(19) United States
(12) Patent Application Publication
(10) Pub. No.: US 2015/0332421 A1
(43) Pub. Date: Nov. 19, 2015

(54) CONCEPTS FOR GUARANTEEING ADDED VALUE

(71) Applicant: UNITED PARCEL SERVICE OF AMERICA, INC., ATLANTA, GA (US)

(72) Inventors: TODD SNYDER, ANAHEIM, CA (US); BRIAN FOUNTAIN, MONROE, NY (US)

(73) Assignee: UNITED PARCEL SERVICE OF AMERICA, INC., ATLANTA, GA (US)

(21) Appl. No.: 14/278,799

(22) Filed: May 15, 2014

(51) Int. Cl. G06Q 50/18; G06Q 30/06

(52) U.S. Cl. CPC G06Q 50/188; G06Q 30/06

(57) ABSTRACT

Various embodiments are directed to concepts for providing a guaranteed added value to a potential customer. According to various embodiments, a vendor of products and/or services may obtain customer data comprising data regarding the sought out products or services to be provided by the vendor. The vendor may identify one or more products and/or services to be offered to the potential customer, and generate a proposal to be presented to the potential customer, wherein the proposal comprises a guaranteed added value. After implementing the one or more products and/or services, the vendor may monitor the provided products and/or services to determine the added value realized by the potential customer that is at least in part attributable to the provided products and/or services. If the added value realized by the potential customer is less than the guaranteed added value, the vendor may reimburse the potential customer for the difference.

### BACKGROUND

Vendors (e.g., providers of products and/or services) and potential customers often negotiate the price, products and/or services to be included in a supply contract. Often these negotiations focus on the quantity and quality of products and/or services to be provided, as well as the cost to receive these products and/or services. Many of these negotiations take place prior to entering into a confidentiality agreement or non-disclosure agreement, in which case the vendor may be forced to disclose confidential information with no guarantee that such information will be kept private by the potential customer.

During supply contract negotiations, the potential customer may seek additional information in order to determine whether the vendor's proposed solutions will add value to the customer's business. This added value may be in the form of cost savings over the customer's current activities, or it may be in the form of increased revenues through higher customer product sales, as non-limiting examples. This added value calculation may be an effective means for a potential customer to compare the offerings of multiple vendors seeking to gain the potential customer's business. However, vendors may additionally present incentive programs with defined values to be realized by the potential customer. As a result of this combination of “soft” savings that may result from implementation of specific products and/or services, and “hard” savings from pre-defined incentive programs, potential customers often need to determine a method of comparing offered products and/or services from several vendors.

Therefore, a need exists for improved systems and methods that allow a vendor to effectively offer guaranteed products and/or services to potential customers without revealing significant confidential information, while allowing a potential customer to evaluate the potential added value for their business.

### BRIEF SUMMARY

Various embodiments of the present invention comprise a computer-implemented method for providing a guaranteed added value, the method comprising steps for: (1) receiving and storing in one or more memory storage areas customer data associated with at least one potential customer and vendor data associated with one or more products potentially offerable to the at least one potential customer; (2) determining, via one or more computer processors, one or more products to be offered to the potential customer, the one or more offered products being selected from the one or more potentially offerable products; (3) determining, via the one or more computer processors, a guaranteed added value for the potential customer utilizing the products to be offered based at least in part upon a comparison of the customer data and the products to be offered to the potential customer; (4) implementing the products to be offered to the potential customer; (5) monitoring, via the one or more computer processors, the implemented products to determine a total added value amount realized by the potential customer; (6) comparing, via the one or more computer processors, the total added value amount realized by the potential customer and the guaranteed added value; (7) in response to a determination that the amount realized is greater than or equal to the guaranteed added value, generating, via the one or more computer processors, a communication to one or more users notifying the one or more users of the determination; and (8) in response to a determination that the amount realized is less than the guaranteed added value, facilitating, via the one or more computer processors, a payout to the potential customer.

Various embodiments of the present invention may comprise a system for providing a guaranteed added value, said system comprising one or more memory storage areas and one or more computer processors configured to: (1) receive and store in one or more memory storage areas customer data associated with at least one potential customer and vendor data associated with one or more products potentially offerable to the at least one potential customer; (2) determine one or more products to be offered to the potential customer, the one or more offered products being selected from the one or more potentially offerable products; (3) determine a guaranteed added value for the potential customer utilizing the products to be offered based at least in part upon a comparison of the customer data and the products to be offered to the potential customer; (4) implement the products to be offered to the potential customer; (5) monitor the implemented products to determine a total added value amount realized by the potential customer; (6) compare the total added value amount realized by the potential customer and the guaranteed added value; (7) in response to a determination that the amount realized is greater than or equal to the guaranteed added value, generate a communication to one or more users notifying the one or more users of the determination; and (8) in response to a determination that the amount realized is less than the guaranteed added value, facilitate a payout to the potential customer.

Other embodiments of the present invention may comprise a non-transitory computer program product comprising at least one computer-readable storage medium having computer-readable program code portions embodied therein, the computer-readable program code portions comprising: (1) an executable portion configured for receiving and storing in one or more memory storage areas customer data associated with at least one potential customer and vendor data associated with one or more products potentially offerable to the at least one potential customer; (2) an executable portion configured for determining one or more products to be offered to the potential customer, the one or more offered products being selected from the one or more potentially offerable products; (3) an executable portion configured for determining a guaranteed added value for the potential customer utilizing the products to be offered based at least in part upon a comparison of the customer data and the products to be offered to the potential customer; (4) an executable portion configured for implementing the products to be offered to the potential customer; (5) an executable portion configured for monitoring the implemented products to determine a total added value amount realized by the potential customer; (6) an executable portion configured for comparing the total added value amount realized by the potential customer and the guaranteed added value; (7) an executable portion configured for, in response to a determination that the amount realized is greater than or equal to the guaranteed added value, generating a communication to one or more users notifying the one or more users of the determination; and (8) an executable portion configured for, in response to a determination that the amount realized is less than the guaranteed added value, facilitating a payout to the potential customer.

### BRIEF DESCRIPTION OF THE DRAWINGS

Reference will now be made to the accompanying drawings, which are not necessarily drawn to scale, and wherein:

FIG. 1 is a block diagram of a system 20 according to various embodiments;

FIG. 2A is schematic block diagram of a server 200 according to various embodiments;

FIG. 2B is schematic block diagram of an exemplary user device 120 according to various embodiments;

FIG. 3 illustrates an overall process flow for various modules of the server 200 according to various embodiments;

FIG. 4 illustrates a schematic diagram of various databases that are utilized by the system 20 shown in FIG. 1 according to various embodiments;

FIG. 5 is a schematic block diagram of a data module 500, a solutions module 600, a proposal module 700, a monitor module 800, and a report module 900, all as also illustrated in FIG. 2A according to various embodiments;

FIG. 6 illustrates an exemplary process flow according to various embodiments for the data module 500 shown in FIGS. 2A and 5;

FIG. 7 illustrates an exemplary process flow according to various embodiments for the solutions module 600 shown in FIGS. 2A and 5;

FIG. 8 illustrates an exemplary process flow according to various embodiments for the proposal module 700 shown in FIGS. 2A and 5;

FIG. 9 illustrates an exemplary process flow according to various embodiments for the monitor module 800 shown in FIGS. 2A and 5; and

FIG. 10 illustrates an exemplary process flow according to various embodiments for the report module 900 shown in FIG. 5.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

Overview

Various embodiments of the invention are directed to systems and methods for offering a guaranteed added value for products to be provided to potential customers. In various embodiments, a vendor obtains detailed information about the potential customer, which may comprise the potential customer's currently utilized products and/or services, business model, corporate structure, current expenditures on supplies, and/or the like, as a non-limiting example. The vendor may then utilize this information to determine the potential value that the vendor can add and guarantee to the business through their services. The added value to the customer's business may take the form of cost savings over the potential customer's current business model, or it may take the form of increased revenue.

The vendor may then determine the services to be offered to the potential customer, and create a bid package comprising a proposal to be presented to the customer. The proposal presented to the potential customer may omit confidential information regarding the underlying products and/or services to be provided to the potential customer, and instead may include only an indication of the guaranteed added value. Through the indicated guaranteed added value, the vendor may guarantee that, if the prospective customer ultimately implements the underlying products and/or services provided by the vendor, the customer will realize an added value of at least the guaranteed added value. In certain embodiments in which the potential customer implements the underlying products and/or services, but does not realize the guaranteed added value, the vendor may reimburse the potential customer for the difference between the realized added value and the guaranteed added value. In various embodiments, the vendor may provide currency, products, and/or services to the potential customer in order to reimburse the potential customer.

The vendor may implement additional monitoring metrics, systems, and methods to evaluate whether the provided services, over time, contribute to the guaranteed added value. In certain embodiments, if the monitoring services reveal that the potential customer is not receiving the increased value as guaranteed by the vendor, the vendor may reimburse the customer for the difference between the added value actually realized and the guaranteed added value. In other embodiments, the vendor may incorporate additional products and/or services, or modify the underlying products and/or services to alleviate the difference between the guaranteed added value and the realized added value.

Exemplary Apparatuses, Methods, Systems, Computer Program Products, & Computing Entities

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media may include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

Exemplary Architecture of System 20

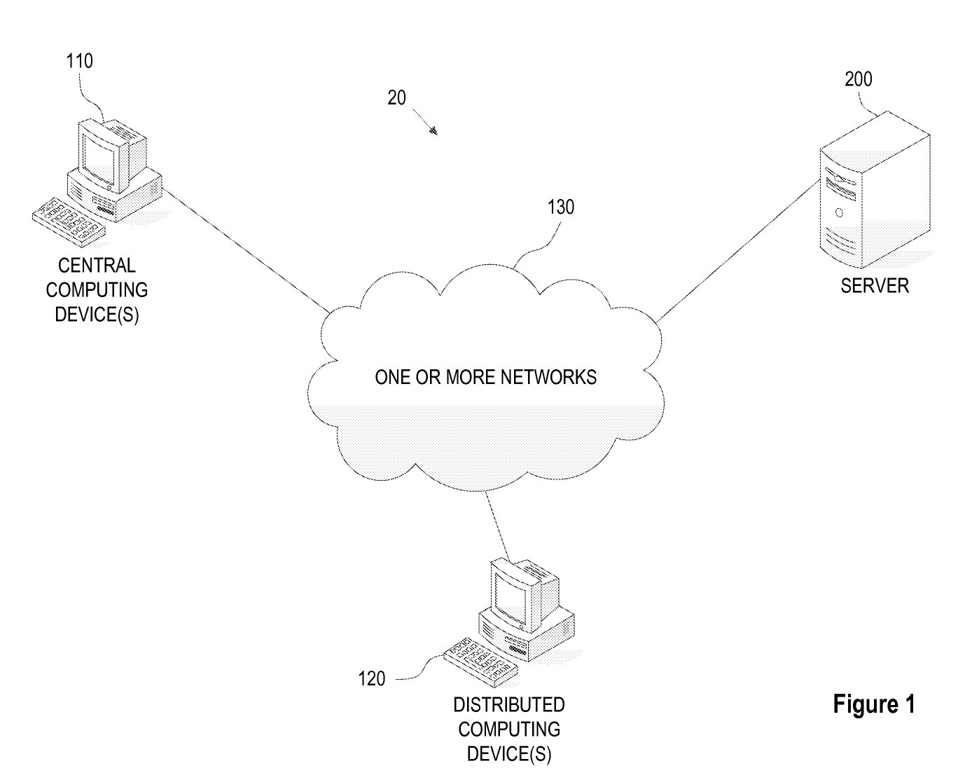

FIG. 1 is a block diagram of a system 20 that can be used in conjunction with various embodiments of the present invention. In at least the illustrated embodiment, the system 20 may include one or more central computing devices 110 and one or more distributed computing devices 120, all configured in communication with a central server 200 via one or more networks 130. While FIG. 1 illustrates the various system entities as separate, standalone entities, the various embodiments are not limited to this particular architecture.

According to various embodiments of the present invention, the one or more networks 130 may be capable of supporting communication in accordance with any one or more of a number of second-generation (2G), 2.5G, third-generation (3G), and/or fourth-generation (4G) mobile communication protocols, or the like. More particularly, the one or more networks 130 may be capable of supporting communication in accordance with 2G wireless communication protocols IS-136 (TDMA), GSM, and IS-95 (CDMA). Also, as a non-limiting example, the one or more networks 130 may be capable of supporting communication in accordance with 2.5G wireless communication protocols GPRS, Enhanced Data GSM Environment (EDGE), or the like. In addition, as another non-limiting example, the one or more networks 130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another non-limiting example, each of the components of the system 20 may be configured to communicate with one another in accordance with techniques such as radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like, as non-limiting examples.

Although the distributed computing device(s) 120, the central computing device(s) 110, and the server 200 are illustrated in FIG. 1 as communicating with one another over the same network 130, these devices may likewise communicate over multiple, separate networks. As a non-limiting example, while the central computing devices 110 may communicate with the server 200 over a wireless personal area network (WPAN) using, for example, Bluetooth techniques, one or more of the distributed computing devices 120 may communicate with the server 200 over a wireless wide area network (WWAN), for example, in accordance with EDGE, or some other 2.5G wireless communication protocol.

According to one embodiment, in addition to receiving data from the server 200, the distributed computing devices 120, may be further configured to collect and transmit data on their own. In various embodiments, the devices 120 may be capable of receiving data via one or more input units or devices, such as a keypad, touchpad, barcode scanner, radio frequency identification (RFID) reader, interface card (e.g., modem, etc.) or receiver. The devices 120 may further be capable of storing data to one or more volatile or non-volatile memory modules, and outputting the data via one or more output units or devices, as a non-limiting example, by displaying data to the user operating the device, or by transmitting data, for example, over the one or more networks 130.

Exemplary Server 200

In various embodiments, the server 200 includes various systems for performing one or more functions in accordance with various embodiments of the present invention, including those more particularly shown and described herein. It should be understood, however, that the server 200 might include a variety of alternative devices for performing one or more like functions, without departing from the spirit and scope of the present invention. As a non-limiting example, at least a portion of the server 200, in certain embodiments, may be located on the distributed computing device(s) 120, as may be desirable for particular applications.

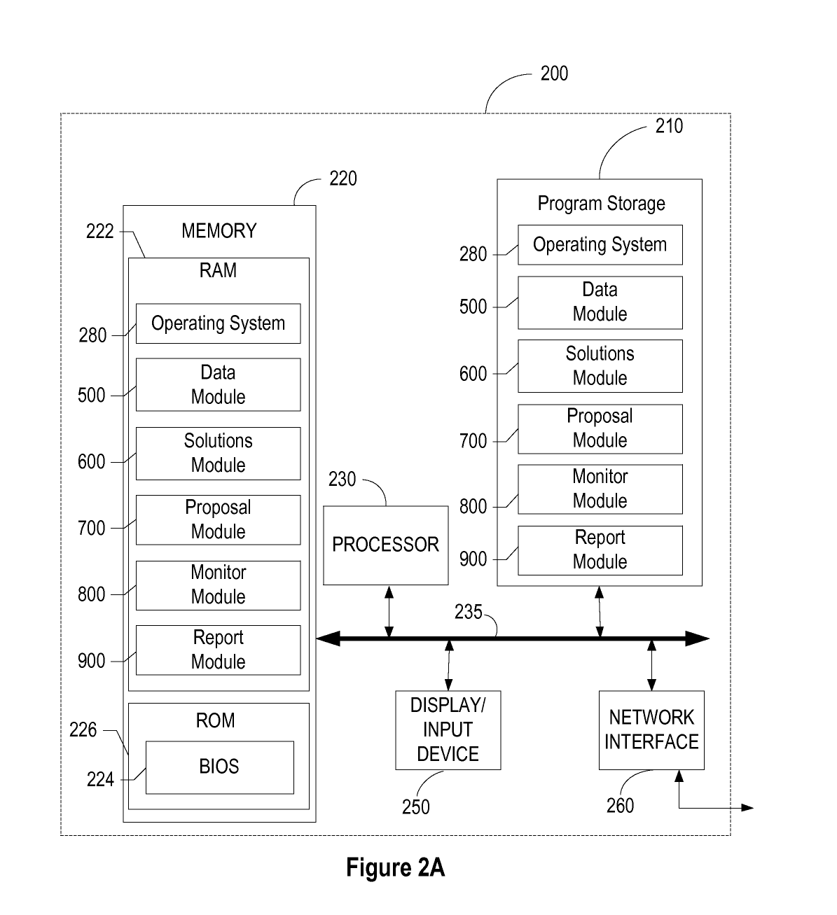

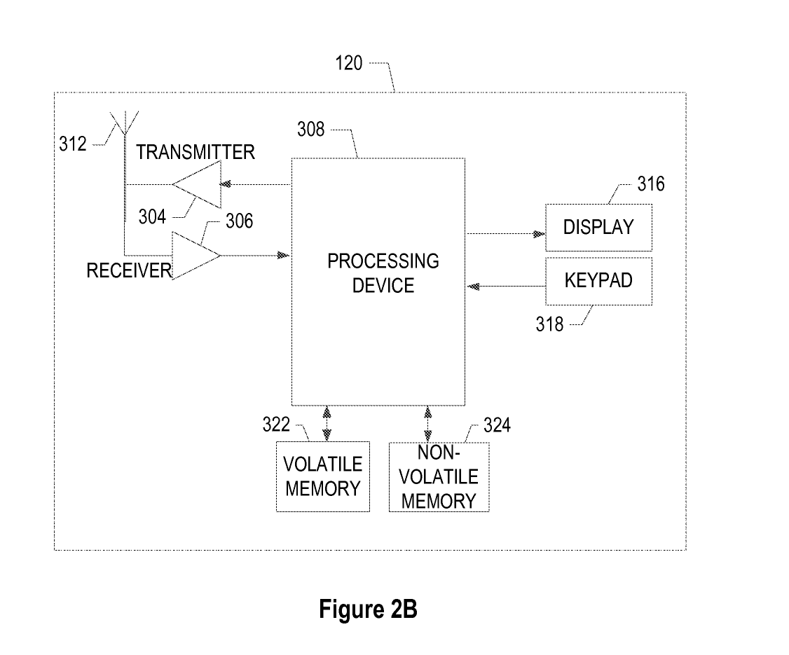

FIG. 2A is a schematic diagram of the server 200 according to various embodiments. The server 200 includes a processor 230 that communicates with other elements within the server via a system interface or bus 235. Also included in the server 200 is a display/input device 250 for receiving and displaying data. This display/input device 250 may be, as a non-limiting example, a keyboard or pointing device that is used in combination with a monitor. The server 200 further includes memory 220, which preferably includes both read only memory (ROM) 226 and random access memory (RAM) 222. The server's ROM 226 is used to store a basic input/output system 224 (BIOS), containing the basic routines that help to transfer information between elements within the server 200. Various ROM and RAM configurations have been previously described herein.

In addition, the server 200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 210 are connected to the system bus 235 by an appropriate interface. The storage devices 210 and their associated computer-readable media provide nonvolatile storage for a personal computer. As will be appreciated by one of ordinary skill in the art, the computer-readable media described above could be replaced by any other type of computer-readable media known in the art. Such media include, as a non-limiting example, magnetic cassettes, flash memory cards, digital video disks, and Bernoulli cartridges.

Although not shown, according to an embodiment, the storage device 210 and/or memory of the server 200 may further provide the functions of a data storage device, which may store historical and/or currently active proposal data that may be accessed by the server 200. In this regard, the storage device 210 may comprise one or more databases. The term “database” refers to a structured collection of records or data that is stored in a computer system, such as via a relational database, hierarchical database, or network database and as such, should not be construed in a limiting fashion.

A number of program modules comprising, as a non-limiting example, one or more computer-readable program code portions executable by the processor 230, may be stored by the various storage devices 210 and within RAM 222. Such program modules include an operating system 280, a data module 500, a solutions module 600, a proposal module 700, a monitor module 800, and a report module 900. In these and other embodiments, the various modules 500, 600, 700, 800, 900 control certain aspects of the operation of the server 200 with the assistance of the processor 230 and operating system 280. In still other embodiments, it should be understood that one or more additional and/or alternative modules may also be provided, without departing from the scope and nature of the present invention.

In various embodiments, the program modules 500, 600, 700, 800, 900 are executed by the server 200 and are configured to generate one or more graphical user interfaces, reports, instructions, and/or notifications/alerts, all accessible and/or transmittable to various users of the system 20. In certain embodiments, the user interfaces, reports, instructions, and/or notifications/alerts may be accessible via one or more networks 130, which may include the Internet or other feasible communications network, as previously discussed. The operation and interaction of the program modules 500, 600, 700, 800, 900 is described in further detail elsewhere herein.

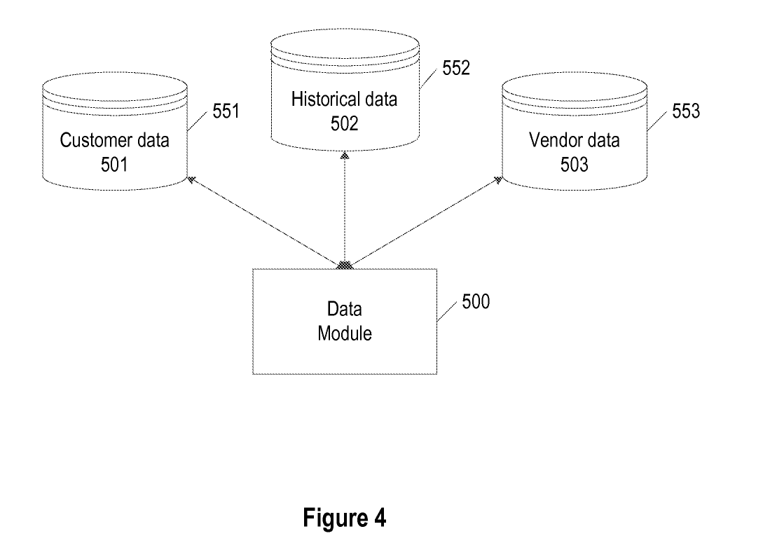

In various embodiments, it should also be understood that one or more of the modules 500, 600, 700, 800, 900 may be alternatively and/or additionally (e.g., in duplicate) stored locally on one or more of the distributed computing devices 120 and may be executed by one or more processors of the same. According to various embodiments, the modules 500, 600, 700, 800, 900 may send data to, receive data from, and utilize data contained in one or more databases (see FIG. 4), which may be comprised of one or more separate, linked and/or networked databases.

Also located within the server 200 is a network interface 260 for interfacing and communicating with other elements of the one or more networks 130. It will be appreciated by one of ordinary skill in the art that one or more of the server 200 components may be located geographically remotely from other server components. Furthermore, one or more of the server 200 components may be combined, and/or additional components performing functions described herein may also be included in the server.

While the foregoing describes a single processor 230, as one of ordinary skill in the art will recognize, the server 200 may comprise multiple processors operating in conjunction with one another to perform the functionality described herein. In addition to the memory 220, the processor 230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. As a non-limiting example, a mesh network of two or more personal computers (PCs), similar electronic devices, or handheld portable devices, collaborating with one another to provide the functionality described herein in association with the server 200 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

Distributed Computing Device(s) 120

FIG. 2B provides an illustrative schematic representative of a distributed computing device 120 that can be used in conjunction with various embodiments of the present invention. Distributed computing devices 120 can be operated by various parties. As used herein, the term “computing device” may refer to, as non-limiting examples, one or more computers, computing entities, desktops, mobile phones, tablets, phablets, notebooks, laptops, distributed systems, gaming consoles (e.g., Xbox, Play Station, Wii), watches, glasses, key fobs, RFID tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 2B, a distributed computing device 120 may include an antenna 312, a transmitter 304 (e.g., radio), a receiver 306 (e.g., radio), and a processing element 308 that provides signals to and receives signals from the transmitter 304 and receiver 306, respectively.

The signals provided to and received from the transmitter 304 and the receiver 306, respectively, may include signaling data in accordance with an air interface standard of applicable wireless systems to communicate with various entities, such as the server 200, the central computing devices 110, and/or the like. In this regard, the distributed computing devices 120 may be capable of operating with one or more air interface standards, communication protocols, modulation types, and access types. More particularly, the distributed computing devices 120 may operate in accordance with any of a number of wireless communication standards and protocols. In a particular embodiment, the distributed computing devices 120 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the distributed computing devices 120 may, according to various embodiments, communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The distributed computing devices 120 can also download changes, add-ons, and updates, for instance, to its firmware, software (e.g., including executable instructions, applications, program modules), and operating system.

According to one embodiment, the distributed computing device 120 may include a location determining device and/or functionality. As a non-limiting example, the distributed computing device 120 may include a GPS module adapted to acquire, as a non-limiting example, latitude, longitude, altitude, geocode, course, and/or speed data. In one embodiment, the GPS module acquires data, sometimes known as ephemeris data, by identifying the number of satellites in view and the relative positions of those satellites.

The distributed computing device 120 may also comprise a user interface (that can include a display 316 coupled to a processing element 308) and/or a user input interface (coupled to a processing element 308). The user input interface can comprise any of a number of devices allowing the distributed computing device 120 to receive data, such as a keypad 318 (hard or soft), a touch display, voice or motion interfaces, or other input device. In embodiments including a keypad 318, the keypad can include (or cause display of) the conventional numeric (0-9) and related keys (#, *), and other keys used for operating the distributed computing device 120 and may include a full set of alphabetic keys or set of keys that may be activated to provide a full set of alphanumeric keys. In addition to providing input, the user input interface can be used, as a non-limiting example, to activate or deactivate certain functions, such as screen savers and/or sleep modes.

The distributed computing device 120 can also include volatile storage or memory 322 and/or non-volatile storage or memory 324, which can be embedded and/or may be removable. As a non-limiting example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the distributed computing device 120.

Server 200 Logic Flow

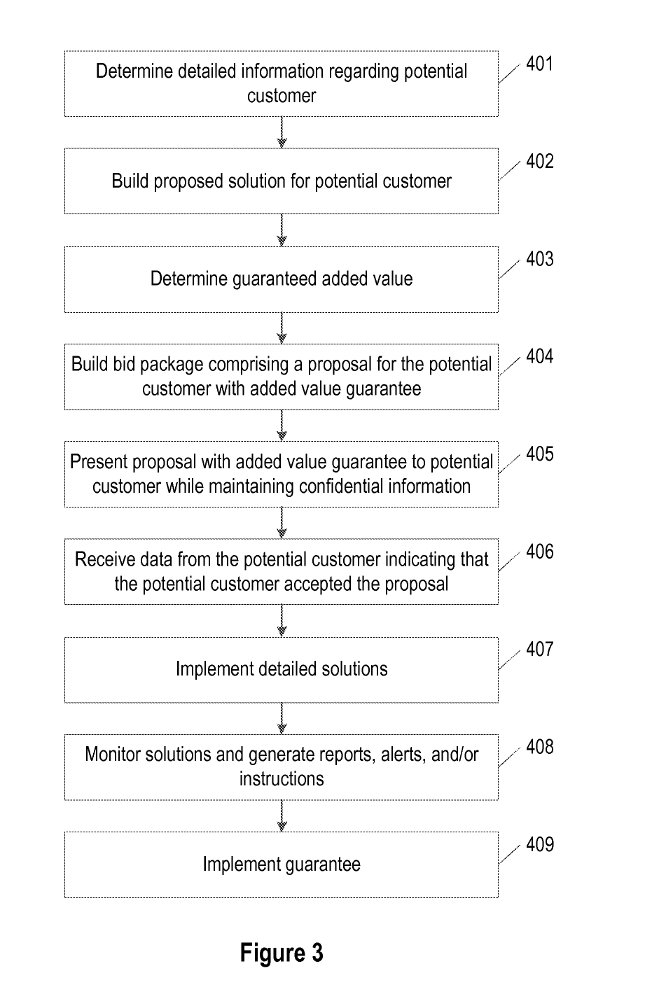

Reference is now made to FIG. 3, which illustrates various logical process flows executed by various embodiments of the modules described previously herein. According to one embodiment, the method may be initiated when a vendor (e.g., vendor of products and/or services) seeks to create a bid package for a potential customer (referred to herein as “potential customer” or “customer” interchangeably). A vendor may be an individual, an organization, a department within an organization, a representative of an organization and/or a person, and/or the like. A vendor may offer one or more products and/or services to customers and potential customers. A vendor may include a common carrier providing shipping services, such as the non-limiting example of United Parcel Service of America, Inc. As a non-limiting example, a vendor may provide item shipping and delivery services to customers and potential customers. Like vendors, a customer or potential customer may be an individual, an organization, a department within an organization, a representative of an organization and/or person, and/or the like. It should also be understood that although referred to herein as a “potential” customer, a potential customer may include a potential customer not currently associated with the vendor, or a current customer to whom a vendor may potentially offer additional or new products and/or services.

A method according to various embodiments of the present invention may be initiated to create one or more proposals in response to one or more Requests for Proposals (RFPs), or it may begin as an unsolicited proposal to be presented to a potential customer. As will be understood by one skilled in the art, a RFP may be a general RFP seeking proposals from multiple vendors, or it may be a specific RFP seeking proposals from a single vendor. The RFP may comprise requirements that each bidding vendor must meet, and may detail the products and/or services sought by the potential customer. As a non-limiting example, a RFP may specify that a potential customer is seeking item shipping, delivery, and/or logistics services for the potential customer's vaccination production business.

According to various embodiments of the present invention, a vendor may begin by obtaining detailed information regarding the potential customer's business (step 401 of FIG. 3). The vendor may obtain the detailed information regarding the potential customer's business from the RFP itself, from publicly available sources (e.g., brochures, websites, and/or other materials provided by the potential customer), from direct contact with the potential customer (e.g., via telephone, video conference, email, text message, in-person meetings, and/or the like), and/or the like. In various embodiments, the vendor may obtain information regarding the current business practices of the potential customer, alternative products and/or services currently in use by the potential customer, current vendor contract expenditures, the size of the potential customer (e.g., defined by the number of employees, market-cap, and/or the like), the products and/or services provided by the potential customer, the potential customer's expenditure budget for the RFP, seasonal changes in the potential customer's business (e.g., seasonal hiring, seasonal sales increases, and/or the like), and/or the like. In various embodiments, the vendor may obtain information at least tangentially related to the products and/or services offered by the vendor, such that the vendor may determine whether the potential customer can realize a likely cost savings and/or revenue increase as a result of utilizing at least one of the products and/or services offered by the vendor. As a non-limiting example, the vendor may determine that a particular shipping strategy will either provide cost savings or increased revenue to the potential customer, while meeting the requirements included in the RFP.

The vendor may then utilize the information obtained during step 401 to determine one or more possible products and/or services to be offered to the potential customer (step 402 of FIG. 3). As will be understood by one skilled in the art, the products and/or services to be offered to the potential customer may comprise one or more products and/or services offered to existing or former customers of the vendor, or may comprise one or more new products and/or services not currently offered to current or former customers of the vendor. In various embodiments, the vendor may create new products and/or services specifically for the potential customer, or the vendor may customize existing products and/or services for the potential customer. As a non-limiting example, the vendor may offer to provide delivery services for the potential customer having a guaranteed maximum transit time to one or more pre-defined destinations.

During step 403, the vendor may analyze the obtained information regarding the potential customer, information regarding the products and/or services to be offered to the potential customer (e.g., the costs realized by the potential customer in implementing the concepts offered by the vendor, the cost savings realized by the potential customer in implementing the concepts offered by the vendor, the revenue realized by the potential customer that is at least in part attributable to the concepts offered by the vendor), and/or historical data regarding the value obtained by current and former customers implementing concepts offered by the vendor to determine a guaranteed added value to be offered to the customer. The guaranteed added value may represent a minimum amount of value the potential customer is likely to receive if the potential customer chooses to implement the products and/or services related to the vendor's proposal. The guaranteed added value may comprise cost savings, increased revenues, and/or a combination of cost savings and increased revenues that the potential customer is likely to realize as a result of implementing the vendor's products and/or services. In various embodiments, the guaranteed added value may represent an added value the potential customer is likely to realize over a predefined time frame, a predefined volume, a predefined expenditure, and/or the like. As a non-limiting example, the guaranteed added value may be the amount a potential customer is likely to realize, in total, over a period of 5 years. The guaranteed added value may be in the form of a defined amount of currency (e.g., $100,000), a percentage (e.g., savings of 0.5% of total revenue or a 1% increase in profits), and/or the like. In various embodiments, such guaranteed added value may be based at least in part on the products and/or services offered by the vendor and the information obtained at step 401. As a non-limiting example, the vendor may determine that, based on the shipping services currently in use by the potential customer and the shipping services offered by the vendor, the potential customer is likely to save a minimum of $50,000 by implementing the vendor's services.

The guaranteed added value may vary based on the occurrence of one or more particular circumstances. In various embodiments, the guaranteed added value may be based on the presumption that the potential customer will utilize the products and/or services provided by the vendor for a given period of time, for a specified volume, and/or until the occurrence of some event. As a non-limiting example, the vendor may determine that the potential customer is likely to save $50,000 if the potential customer utilizes the products and/or services provided by the vendor for twelve months, shipping a minimum of 100 items each week. As an additional non-limiting example, the vendor may determine that the potential customer is likely to save $30,000 if the potential customer utilizes the products and/or services provided by the vendor to facilitate in shipping 2,000 items.

In various embodiments, the guaranteed added value may be based on presumptions that the potential customer will act in a certain way. As a non-limiting example, the guaranteed added value may be based on a presumption that the potential customer will utilize the vendor's products and/or services in the manner specified by the vendor. Alternatively, the guaranteed added value may be based at least in part on the products and/or services utilized by the potential customer. As a non-limiting example, the guaranteed added value may be $5,000 for every $2,000 the potential customer spends on services provided by the vendor. As an additional non-limiting example, the guaranteed added value may be $2,000 for every 150 items shipped by the potential customer.

In various embodiments, the guaranteed added value may represent a low-risk added value amount. A low-risk added value amount may be determined based on several factors, such factors comprising historical data maintained by the vendor, the potential customer's current business practices, the potential customer's current business sales volume, the potential customer's size, the vendor's risk tolerance, and/or the like. In various embodiments, a low-risk added value amount may be an amount that the potential customer has at least a predetermined chance of realizing. As a non-limiting example, a low-risk added value amount may be an amount that the potential customer has a 95% chance of realizing if the potential customer implements the products and/or services provided by the vendor (as will be understood by one skilled in the art, the vendor would consequently have about a 5% chance of having to transfer any value to the potential customer as a result of the potential customer realizing an added value less than the guaranteed added value). As an additional non-limiting example, a low-risk added value amount may be an amount that the potential customer has a 99% chance of realizing if the potential customer implements the products and/or services provided by the vendor (as will be understood by one skilled in the art, the vendor would consequently have about a 1% chance of having to transfer any value to the potential customer as a result of the potential customer realizing an added value less than the guaranteed added value).

In various embodiments, the vendor may build a bid package detailing the added value guarantee at step 404, and communicate a proposal contained in the bid package to the potential customer at step 405 of FIG. 3. Such communication may be in the form of a physical mailing, and/or an electronic communication such as an e-mail, text message, input into a web page, input into a database, and/or the like. In various embodiments, the proposal may comprise information regarding the guaranteed added value and/or regarding at least a portion of the products and/or services that will be provided by the vendor under the terms of the bid. As a non-limiting example, the vendor may specify that the potential customer may utilize proprietary software to schedule shipments from the potential customer's location. However, because the vendor may include a guaranteed added value in the proposal, the proposal may omit detailed information regarding the products and/or services to be provided by the vendor. The guaranteed added value may be offered to the potential customer instead of detailed information regarding the products and/or services to be provided under the terms specified in the proposal. In various embodiments, the vendor may withhold information regarding intellectual property of the vendor in the proposal. In this way, the vendor may avoid providing confidential information to the potential customer until the customer accepts the terms of the proposal. Alternatively, the vendor may provide information regarding only a portion of the products and/or services to be offered. In various embodiments, the vendor proposal may include information regarding the guaranteed added value, and omit information regarding the products and/or services necessary to utilize the products and/or services. As will be understood by one skilled in the art, limiting the information provided to the potential customer may prevent the potential customer from utilizing the products and/or services without employing the vendor.

In various embodiments, the proposal may additionally comprise conditions or qualifications on the guaranteed added value. Such conditions or qualifications may ensure that the potential customer cannot accept the vendor's proposal, fail to implement the provided products and/or services and/or fail to adhere to the specified conditions and/or qualifications, and collect the guaranteed added value from the vendor. In various embodiments, such qualifications may include a requirement that the potential customer utilize the products and/or services provided by the vendor. The vendor may specify that the guaranteed added value is likely to result from a specified level of integration into the customer's business.

After transmitting the proposal to the potential customer, the vendor may receive an indication on whether the potential customer accepts or rejects the proposal at step 406. If the potential customer chooses to reject the proposal presented by the vendor, the method may end after Block 405. However, if the potential customer chooses to accept the bid package presented by the vendor, the vendor may receive such indication from the potential customer in step 406. It should be understood by one skilled in the art that a potential customer becomes a customer upon acceptance of the proposal. However, for consistency and clarity, the customer is referred to generally as a potential customer throughout.

In various embodiments, the vendor may require a Non-Disclosure Agreement (NDA) or confidentiality agreement prior to revealing additional information to the potential customer. As a non-limiting example, the vendor may include certain proprietary products, methods, and/or the like (collectively referred to herein as “proprietary products”) as a part of those products and/or services provided to the potential customer. In such circumstances, the vendor may require a contractual agreement with the potential customer that the potential customer will not share information regarding such proprietary products without the authorization of the vendor.

At step 407 the vendor may begin implementing the products and/or services to be provided to the potential customer. In various embodiments, implementing the products and/or services may comprise completing the tasks or making the products and/or services available to the potential customer as specified by the bid package. In various embodiments, the products and/or services to be provided by the vendor may be dependent on the negotiations between the vendor and the potential customer. The products and/or services provided by the vendor may be substantially the same products and/or services identified during step 402. In various embodiments, the vendor's ability to implement the services may at least partially be dependent on the potential customer's cooperation.

The vendor and/or potential customer may monitor the solutions provided by the products and/or services provided (e.g., the value added realized by the potential customer) in order to determine the total added value attributable to the products and/or services (step 408 of FIG. 3). In various embodiments, the guaranteed added value may be at least partially dependent on the added value attributable to the products and/or services provided by the vendor. Therefore, the vendor and/or the potential customer may determine various metrics, tests, observations, and/or the like that can indicate the results of the products and/or services provided by the vendor. The vendor and/or potential customer may monitor the results attributable to the provided products and/or services for a defined period of time (e.g., corresponding to the length of time specified in the bid package), or may monitor the results attributable to the provided products and/or services indefinitely.

In various embodiments, the system 20 may be configured to generate one or more reports and/or alerts to notify users of the system and/or the potential customer about the status of the products and/or services provided by the vendor at step 408. Such reports and/or alerts may be generated periodically or in response to a particular input. As a non-limiting example, the reports and/or alerts may be generated in order to notify the vendor when a potential customer realizes the guaranteed added value. Such reports and/or alerts may additionally be configured to notify the vendor when the potential customer does not realize the guaranteed added value in accordance with the accepted proposal so as to facilitate the vendor reimbursing the potential customer. Additionally, the reports and/or alerts may be generated at other points in time, so as to notify the vendor of whether the potential customer is likely to realize the guaranteed added value. Notification prior to the expiration of the time frame denoted for realizing the guaranteed added value may allow the vendor and/or the potential customer to modify or add products and/or services provided to the potential customer so as to mitigate the likelihood that the potential customer will not realize the guaranteed added value prior to the expiration of the specified time frame. Alternatively, the reports and/or alerts can be generated so as to notify the vendor of whether the potential customer is likely to realize the guaranteed added value over a predefined expenditure (e.g., $100,000 spent on shipping services) or predefined volume (e.g., 2,000 items shipped).

Moreover, the reports and/or alerts may include an indication of whether the potential customer is complying with any requirements, conditions, and/or qualifications associated with the guaranteed added value. By monitoring the potential customer's implementation, and notifying the vendor of the status of the implementation, the vendor may determine that the potential customer has not complied with the requirements, conditions, and/or qualifications associated with the guaranteed added value, and therefore the vendor need not reimburse the potential customer for any difference between the guaranteed added value and the realized added value.

The vendor and/or potential customer may utilize the results of the monitoring step (step 408) to determine whether the products and/or services provided by the vendor at least in part caused or contributed to an added value amount realized by the potential customer that is less than, equal to, or exceeding the guaranteed added value (step 409 of FIG. 3). Such determination may be made after a predetermined amount of time, after the happening of a specified event, or at multiple discrete times. In various embodiments in which the vendor and/or potential customer determines that the provided products and/or services at least partially contributed to an added value realized by the potential customer that is equal to or exceeds the guaranteed added value, the method may end at step 409. In various embodiments, the vendor may continue providing products and/or services to the potential customer after determining whether the provided services at least partially contributed to an added value realized by the potential customer that is equal to or exceeds the guaranteed added value.

In various embodiments in which the vendor and/or potential customer determines that the potential customer realized an added value at least partially attributed to the provided products and/or services that was less than the guaranteed added value, the vendor make a payout to the potential customer in the form of transferred value equal to the difference between the guaranteed added value and the realized added value amount. As a non-limiting example, the payout may be in the form of a refund of at least a portion of the funds paid to the vendor by the potential customer, additional products and/or services provided to the potential customer at a reduced cost, goods or products transferred to the potential customer, and/or the like. In various embodiments, the payout may comprise more than one form of value transferred to the potential customer. As a non-limiting example, the vendor may provide a first portion of the transferred value in the form of a refund of at least a portion of the funds paid to the vendor by the potential customer, and a second portion of the transferred value in the form of additional services provided at a reduced cost to the potential customer.

Summary of Exemplary System Operation

As indicated above, various embodiments of the system 20 execute various program modules (e.g., modules 500, 600, 700, 800, and 900) to generate, transmit, monitor, and report on the execution of proposals with guaranteed added values. Such modules allow vendors to generate proposals to be sent to potential customers without disclosing confidential data to the potential customer prior to entering into a confidentiality agreement.

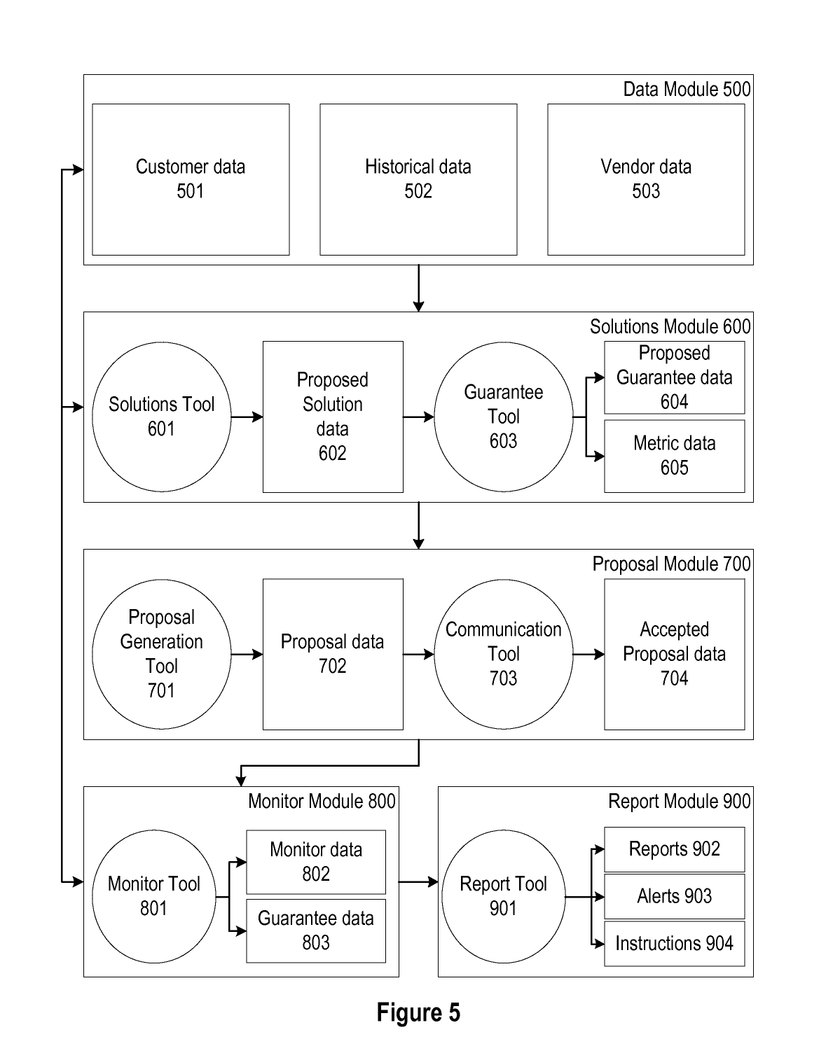

Reference is made initially to FIG. 5, which illustrates the relationship between exemplary program modules in the system 20. As may be understood, a data module 500 may first compile data originating in multiple data sources. As described above, various modules of the system 20 may utilize customer data 501 regarding the potential customer, including data regarding the potential customer's sought out requirements, data regarding the potential customer's business, data regarding the potential customer's budget, and/or the like. In various embodiments, various modules of the system 20 may utilize historical data 502 regarding historical products and/or services offered to current or former customers. In particular, various modules of the system 20 may utilize data regarding the added value realized by the current or former customer, and data regarding the circumstances in which each current or former customer realized the added value. The data module 500 may additionally be configured to receive and compile vendor data 503 comprising data regarding the products and/or services offered by the vendor, data regarding the methods and formats used to submit proposals to potential customers, the resources available to the vendor (e.g., employees, transportation resources, computing power, production capacity, and/or the like), and/or the like.

As will be understood by one skilled in the art, the customer data 501, historical data 502, and vendor data 503 may be received from a variety of sources. As a non-limiting example, the customer data 501 may be obtained from a RFP provided by a potential customer, from publicly available resources (e.g., the potential customer's website, brochures available to the customer, and/or the like), from direct communications with the potential customer, and/or the like. The customer data 501 may be received directly by the data module 500, or it may be received and stored in a customer database 551 as shown in FIG. 4, before being compiled by the data module 500. Likewise, the historical data 502 and vendor data 503 may be received from various modules in the system 20, or it may be received from external sources such as a distributed computing entity 120. In various embodiments, the data module 500 receives the historical data 502 and/or vendor data 503 directly from the sources of the data 502, 503. However, as will be understood by one skilled in the art, the historical data 502 and vendor data 503 may be received and stored in a customer database 551, a historical database 552, and/or a vendor database 553 prior to being compiled by the data module 500. As a non-limiting example, the customer database 551 may be configured to store customer data 501 and/or historical data 502 regarding products and/or services offered to current and former customers in the past.

In various embodiments, the customer data 501 may be stored in a customer database 551, and may comprise data regarding various aspects of a potential customer's business. In various embodiments, the customer database 551 may store customer data 501 for multiple current, former, and/or potential customers. In various embodiments, such customer data 501 may be stored in a plurality of customer profiles, each corresponding to a particular current, former, or potential customer. In certain embodiments, the customer data 501 for each current, former, or potential customer may comprise data regarding the customer's business. As a non-limiting example, the customer data 501 may comprise detailed information regarding the products and/or services offered by the customer, the size of the customer (e.g., determined by number of employees, market cap, and/or the like), the number of locations owned by the customer, the customer's market segment (e.g., retail sales, distribution, manufacturing, and/or the like), the number of items shipped during a particular time period, the seasonal increases and/or decreases in the number of items shipped, and/or the like.

The historical data 502 may be stored in a customer database 551, or in a separate historical database 552. In various embodiments, the historical data 502 may comprise data regarding the products and/or services offered to current and/or former customers of the vendor. Specifically, the historical data 502 may comprise data regarding the added value realized by current and/or former customers that is at least in part attributable to the products and/or services offered by the vendor. The historical data 502 may comprise data regarding the products and/or services provided to the current and/or former customers, the products and/or services sought by the current and/or former customers, the cost savings and/or increased revenue realized by the current and/or former customers, and/or the like. In these and other embodiments, it should be understood that the historical data 502 may comprise a variety of data necessary for various modules in the system 20 to make a determination as to the cause or source of the added value realized by the current and/or former customers.

The vendor data 503 may be stored in a vendor database 553 and/or a historical database 552. As a non-limiting example, the vendor data 503 may comprise data regarding the vendor's business, such as the products and/or services offered and/or offerable by the vendor, the size of the vendor, the resources available to the vendor, and/or the like. Specifically, the vendor data 503 may, in various embodiments, comprise data regarding the costs charged to a customer for each of the products and/or services offered by the vendor. In certain embodiments, the vendor data 503 may also comprise data necessary for various modules of the system 20 to determine the products and/or services to be offered to a potential customer.

Referring back to FIG. 5, the data module 500 may be in communication with a solutions module 600 configured to determine the products and/or services to be offered to the potential customer. In various embodiments, the solutions module 600 may comprise at least a solutions tool 601 and a guarantee tool 602, collectively configured to determine the products and/or services to be offered to the potential customer and the guaranteed added value that should be included in a proposal to be transmitted to the potential customer. Specifically, the solutions tool 601 may be configured to receive the customer data 501 regarding the potential customer and to determine products and/or services to be offered to the potential customer based at least in part on the customer data 501 and/or the vendor data 503. The products and/or services determined by the solutions tool 601 (herein after collectively referred to as the proposed solutions data 602) are received by a guarantee tool 603 configured to determine the appropriate value added guarantee amount to be offered to the potential customer. The guarantee tool 603 may additionally be configured to generate proposed guarantee data 604 comprising data indicating the products and/or services to be offered to the potential customer and the appropriate value added guarantee amount determined based on the products and/or services to be offered. In various embodiments, the guarantee tool 603 may be configured to receive historical data 502 in order to determine the likely added value amount to be realized by the potential customer that is at least in part attributable to the proposed solutions offered. As described above, the guaranteed added value may represent the total amount of added value (in the form of cost savings, increased revenue, and/or the like) the vendor guarantees will be realized by the potential customer that is at least in part attributable to the products and/or services offered by the vendor. In various embodiments, the vendor may present the guaranteed added value with an offer to reimburse the potential customer for the difference between the added value actually realized and the guaranteed added value. As a non-limiting example, if the vendor guarantees that the potential customer will realize at least $100,000 in added value that is at least in part attributable to the proposed solutions over a predetermined period of time, and the potential customer only realizes $20,000 of added value that is at least in part attributable to the proposed solutions, the vendor may reimburse the potential customer for $80,000.

The guarantee tool 603 may be configured to determine metric data 605 comprising tools, observations, metrics, and/or the like (collectively referred to herein as “metrics”) that may be used to determine whether the proposed solutions determined by the solutions tool 601 are projected to contribute to any added value that may be realized by the potential customer. As a non-limiting example, the metrics may comprise a comparison between the amount spent by the potential customer to send an item prior to the implementation of the vendor's proposed solutions and the amount spent by the potential customer to send an item after implementation of the vendor's proposed solutions, multiplied by the number of items sent. As an additional non-limiting example of a metric, the guarantee tool 603 may compare the amount of revenue realized by the potential customer prior to the implementation of the vendor's proposed solutions and the amount of revenue realized by the potential customer after implementation of the vendor's proposed solutions.

In various embodiments, the guarantee tool 603 may be additionally configured to receive information regarding an acceptable level of risk to be applied to a guarantee. The acceptable level of risk may, in various embodiments, be determined from the perspective of the vendor, and may represent the acceptable likelihood that the vendor will be required to reimburse the potential customer under the terms of the guarantee. The guarantee tool 603 may receive vendor data 503 regarding the acceptable level of risk from the perspective of the vendor when calculating a guaranteed added value. In various embodiments, the acceptable level of risk may be in the form of a risk percentage, a risk threshold, a risk tolerance, and/or the like. As a non-limiting example, the vendor may be willing to accept a risk that there no more than a 5% chance that the vendor will be required to reimburse the potential customer under the terms of the agreement. In these and other embodiments, the guarantee tool 603 may be configured to calculate a guaranteed added value for which there is no more than a 5% chance that the vendor will need to reimburse the potential customer.

Alternatively, the guarantee tool 603 may be configured to set a guaranteed added value such that the vendor will never have to pay more than a specified amount to the potential customer. As a non-limiting example, the guarantee tool 603 may be configured to set the guaranteed added value to $20,000 such that the vendor will never have to reimburse the potential customer more than $20,000. Additionally, the guarantee tool 603 may be configured to set risk tolerances for determining guaranteed added values that comply with the acceptable level of risk.

In various embodiments, the guarantee tool 603 may additionally and/or alternatively be configured to calculate a guaranteed added value that falls within an acceptable risk range, or within an acceptable tolerance of the acceptable level of risk. As another non-limiting example, the guarantee tool 603 may be configured to determine a guaranteed added value such that the vendor has a 5%±1% chance of being required to reimburse the potential customer under the terms of guarantee. As will be understood by one skilled in the art, the acceptable level of risk may additionally comprise a minimum amount of risk acceptable to the vendor. In various embodiments, the vendor may desire to present high guarantee amounts to attract potential customers, and therefore the guarantee tool 603 may be configured to calculate a guaranteed added value that meets a minimum level of risk. As a non-limiting example, the guarantee tool 603 may be configured to calculate a guaranteed added value such that the vendor has at least a 10% chance of being required to reimburse the potential customer. As will be understood by one skilled in the art, maximum and minimum levels of risk may be included in a single embodiment such that the guarantee tool 603 may be configured to calculate a guaranteed added value that falls within an acceptable risk range. As an additional non-limiting example, the guarantee tool 603 may be configured to calculate a guaranteed added value such that the vendor has at least a 4% chance of being required to reimburse the potential customer, and no more than a 6% chance of being required to reimburse the potential customer under the terms of the guarantee.

Alternatively, the acceptable level of risk may be calculated from the perspective of the potential customer. In various embodiments, the guarantee tool 603 may be configured to receive customer data 501 comprising an acceptable level of risk from the perspective of the potential customer. The guarantee tool 603 may be configured to determine a guaranteed added value such that the potential customer has at least a predetermined chance of realizing the guaranteed added value. As a non-limiting example, the guarantee tool 603 may determine a guaranteed added value to be included in a proposal such that the potential customer has at least a 95% chance of realizing the guaranteed added value without relying on a reimbursement from the vendor.

In various embodiments, the guarantee tool 603 may additionally and/or alternatively be configured to calculate a guaranteed added value that falls within an acceptable risk range, or within an acceptable tolerance of the acceptable level of risk. As a non-limiting example, the guarantee tool 603 may be configured to determine a guaranteed added value such that the potential customer has a 95%±1% chance of realizing the guaranteed added value without reimbursement from the vendor. As will be understood by one skilled in the art, the acceptable level of risk may additionally comprise a maximum chance that the potential customer will realize the added value amount. As will be understood by one skilled in the art, the minimum and maximum acceptable levels of risk from the perspective of the potential customer may be utilized together, such that the likelihood of realizing the guaranteed added value falls within an acceptable risk range. As another non-limiting example, the guarantee tool 603 may be configured to calculate a guaranteed added value such that the potential customer has at least a 94% chance of realizing the guaranteed added value, and no more than a 96% chance of realizing the guaranteed added value. Alternatively, the guarantee tool 603 may be configured to calculate a guaranteed added value such that the potential customer will likely realize a specified amount of value, regardless of whether it is in the form of realized value or a reimbursement. As yet another non-limiting example, the guarantee tool 603 may be configured to determine the guaranteed added value to be $20,000, such that the potential customer is guarantee to realize at least $20,000.

In various embodiments, at least a portion of the data created by the solutions module 600 (e.g., the proposed solutions data 602 and proposed guarantee data 604) may be transmitted to a proposal module 700. The proposal module 700 may be configured for generating and assembling a proposal to be presented to the potential customer, and for transmitting the proposal to the potential customer for review. In various embodiments, the proposal module 700 may comprise a proposal generation tool 701 and a communication tool 703. Specifically, the proposal generation tool 701 may be configured for assembling a proposal for presenting the proposed solutions and proposed guaranteed added value determined in the solutions module 600. In various embodiments, the proposal generation tool 701 may be configured to receive data regarding a preferred format for presenting the proposal to the potential customer. Alternatively, the proposal generation tool 701 may be configured to determine an appropriate format in which to present the proposal to the potential customer based at least in part on the data to be incorporated therein.

The proposal generation tool 701 may be configured to identify those products and/or services contained in the proposed solution data 602 that are considered confidential. In various embodiments, the proposal generation tool 701 may be configured to omit information regarding those products and/or services identified as confidential when assembling proposal data 702 comprising a proposal to be submitted to a potential customer. In various embodiments, the proposal generation tool 701 may be configured to include information regarding only a portion of the determined products and/or services to be offered to the potential customer. In lieu of more detailed information regarding the products and/or services to be offered to the potential customer, the proposal generation tool 701 may be configured to identify the proposed guaranteed added value.

In various embodiments, the proposal generation tool 701 may be configured to transmit the created proposal data 702 to the communication tool 703 for transmission to the potential customer for review. In various embodiments, the communication tool 703 may be in communication with a network 130 and may be configured to transmit the proposal to the potential customer using one or more of a variety of communication methods. As a non-limiting example, the communication tool 703 may be configured to transmit the proposal to the potential customer via email, text message, fax, and/or the like. In various embodiments, the communication tool 703 may be in communication with a printing device (e.g., an inkjet printer, laser printer, and/or the like) configured to create a hard copy of the proposal to be sent to the potential customer using a shipping service. In these and other embodiments, any of a variety of means of delivery as commonly known and understood in the art may be utilized.

In various embodiments, the communication tool 703 may be configured to receive communications from the potential customer. As a non-limiting example, the communication tool 703 may be configured to receive an accepted version of the proposal or a counter offer presented by the potential customer and generate accepted proposal data 704 based at least in part on the received communications from the potential customer. The communication tool 703 may be configured to automatically reject any counter offers presented by the potential customer, or it may be configured to flag counteroffers for review by an employee of the vendor. In various embodiments, the communication tool 703 may be configured to transmit counter offers to the solutions module 600 to determine whether the vendor can provide the products, services and/or guarantee amounts requested by the potential customer in the counter offer.

In various embodiments, the accepted proposal data 704 received by the communication tool 703 may be transmitted to a monitor module 800 configured to utilize the metric data 605 to determine whether the proposed solutions contributed at least in part to an added value realized by the potential customer. In various embodiments, the monitor module 800 may comprise a monitor tool 801 configured to receive customer data 501 regarding the potential customer at various times during the implementation of the proposed solutions. In various embodiments, the monitor tool may be configured to utilize the metric data 605 to compare the guaranteed added value and the customer data 502 and generate monitor data 802 based at least in part on the results of the comparison. As will be understood by one skilled in the art, the customer data 502 may comprise data regarding the added value actually realized by the potential customer after implementing the vendor's proposed solutions. In various embodiments, the monitor tool 801 may be configured to transmit the monitor data 802 to the data module 500 to be stored as historical data 502. Additionally, the monitor tool 801 may be configured to determine whether the vendor is obligated to reimburse the potential customer for any value not realized as a result of the proposed solutions, and generate guarantee data 803 based at least in part on the results of the determination. In various embodiments, the monitor tool 801 may be configured to make the determination regarding whether the potential customer realized the guaranteed added value after a specified amount of time elapses after the initial implementation of the proposed solutions. In various embodiments, the monitor tool 801 may be configured to determine the appropriate time at which to determine whether the potential customer realized the guaranteed added value based at least in part on the accepted proposal data 704.

Moreover, in various embodiments the monitor module 800 may be configured to transmit at least a portion of the monitor data 802 and guarantee data 803 to a report module 900 configured for generating and transmitting reports 902, alerts 903, and instructions 904 to various program modules and users based at least in part on the data received from the monitor module 800. In various embodiments, the report module 900 may comprise a report tool 901 configured to receive data from the monitor module 800 and determine appropriate reports 902, alerts 903, and/or instructions 904 to be generated and transmitted to various used based at least in part on the content of the received data.

As will be understood by one skilled in the art, the program modules (e.g., 500, 600, 700, 800, and 900) may be configured to operate in any order and/or simultaneously. The system 20 as a whole may be configured to create and monitor multiple proposals simultaneously, and each tool contained within the various modules (e.g., 601, 603, 701, 703, and 801) may be configured to execute tasks associated with multiple proposals simultaneously and/or sequentially.

Although not fully illustrated in FIG. 5, as will be understood by one skilled in the art, the various modules 500, 600, 700, 800, 900 may be in communication with each of the other modules, such that data may be transmitted between any two modules. As a non-limiting example, the metric data 605 generated in the solutions module 600 may be transmitted to the monitor module 800 for initially configuring the monitor tool 801. Additionally, the data generated in each of the modules 600, 700, 800, 900 may be transmitted to the data module 500 for storage as customer data 501, historical data 502, and/or vendor data 503.

Data Module 500

According to various embodiments, as previously mentioned herein, the data module 500 is configured to receive, store, manage, and transmit a variety of customer data 501, historical data 502, and/or vendor data 503. Receipt may be from any of a variety of entities (e.g., a potential customer, a vendor, a regulatory entity, a neutral third party, a recipient of an item shipment, or otherwise) and transmission may be to one or more of the modules 600-900, as will be described in further detail below.

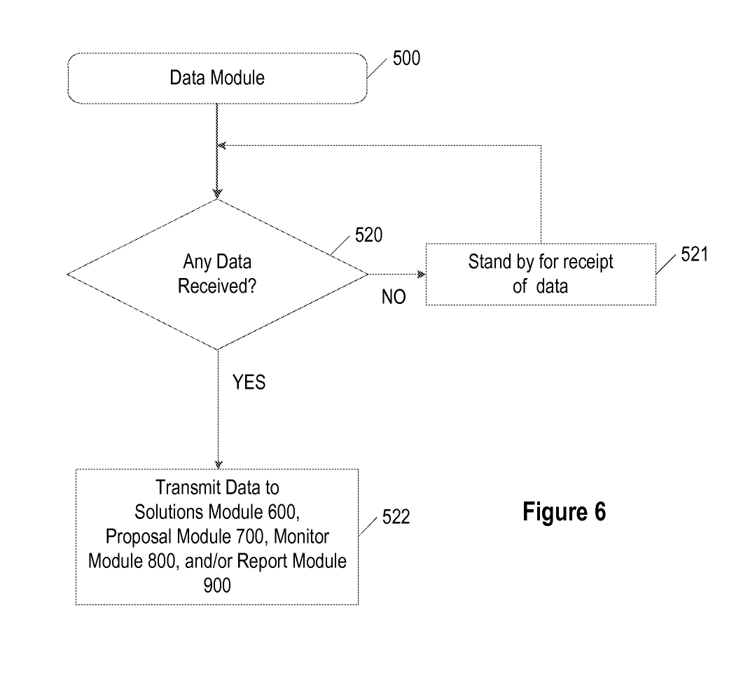

FIG. 6 illustrates steps that may be executed by the data module 500 according to various embodiments. Beginning with step 520, the data module 500 assesses whether any data (e.g., customer data 501, historical data 502, and/or vendor data 503, all as illustrated in FIG. 5) has been received by the module. In certain embodiments, the data module 500 makes this assessment by periodically scanning one or more databases (see FIG. 4) associated with the module and by identifying some portion of data within one or more of the databases that was not present during a previous periodic scan under step 520. Of course, alternative configurations may be envisioned, wherein, as a non-limiting example, the data module 500 may actively receive data (e.g., as input by a user of the system 20 via an interface, whether web-based or otherwise) and upon receipt thereof, execute step 522.

As an initial non-limiting example, the newly received data may comprise potential customer requirement data within the customer data 501 comprising data regarding the products and/or services requested by the potential customer. Such customer requirement data may comprise as a non-limiting example, a textual description of shipping services needed by the potential customer. The received data may alternatively and/or additionally comprise any of the following further non-limiting examples: data regarding products and/or services offered to current and/or former customers, data regarding the potential customer's business, data regarding the current products and/or services offered by the vendor, data regarding metric data utilized in measuring the performance of the products and/or services offered to current and/or former customers, and/or the like.

As previously mentioned, with reference again to FIG. 6, in any of these and still other various embodiments, if “newly received” data (e.g., customer data 501, historical data 502, and/or vendor data 503) is identified, the data module 500 proceeds to step 522; otherwise the module proceeds into a static loop via step 521. During step 521, the data module 500 may be configured to passively stand by for receipt of new data. In certain embodiments, the module 500 may, in step 521, periodically (e.g., every 5 seconds, or at any desirable interval) proactively ping one or more databases contained therein. Various alternative data monitoring configurations may be envisioned, without departing the scope and nature of the present invention, as such are commonly known and understood in the art.

According to various embodiments, during step 522, the data module 500 is configured to transmit at least a portion of data (e.g., customer data 501, historical data 502, and/or vendor data 503) to at least the solutions module 600. In certain embodiments, portions of the data may be alternatively and/or additionally transmitted to the proposal module 700, the monitor module 800, and/or the report module 900. In these and other embodiments, such transmission to various modules may be simultaneous, while in still other embodiments, transmission may be sequential and temporally spaced, as may be desirable or necessary for particular applications. Still further, in certain embodiments, the data module 500 may be configured to automatically perform step 522, while in other embodiments the module may perform such only periodically, at an interval predetermined by one or more users of the system 20, as may be desirable for particular applications. In any of these and still other embodiments, any portion of the data may be otherwise exchanged, whether automatically or upon request therefor, with or from the remaining modules 600-900, as may be desirable for certain applications, as compared with the provision of such data from and by the data module 500 as an initiator thereof.

Solutions Module 600

As previously described, upon receipt and/or retrieval of any portion of data (e.g., customer data 501, historical data 502, and/or vendor data 503), the solutions module 600 is configured to at least execute one or more tools to determine the products and/or services to be offered to the potential customer, and the guaranteed added value to include in the proposal. In at least the illustrated embodiment, such tools comprise a solutions tool 601 and a guarantee tool 603, although additional and/or alternative tools may be provided. The solutions tool 601 may be configured to generate at least proposed solutions data 602, and the guarantee tool 603 may be configured to generate at least proposed guarantee data 604 and metric data 605. Further details in this regard are provided below.

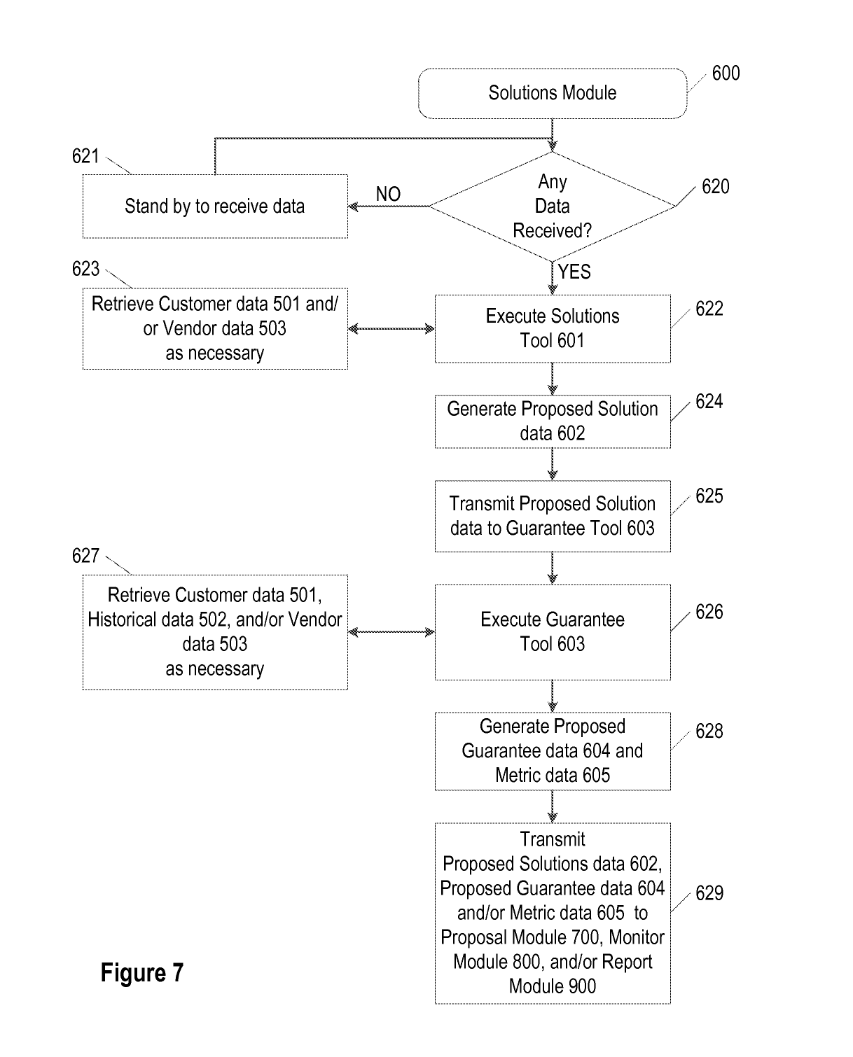

With reference now to FIG. 7, which illustrates the various steps that may be executed by the solutions module 600, according to various embodiments the solutions module is configured to begin at step 620 by determining whether any data has been received thereby. As will be understood by one skilled in the art, the solutions module 600 may utilize procedures similar to those described above in relation to steps 520-521 executed by the data module 500. As a non-limiting example, the solutions module 600 may be configured to periodically and/or continuously proactively retrieve and/or check for new data, as may be transmitted from the data module 500. In other embodiments, the solutions module 600 may merely passively await receipt of data from the data module 500, as may be desirable for particular applications. As may be understood by one skilled in the art, the solutions module 600 may operate in a manner different from the data module 500.

Otherwise, if no data is received in step 620, the solutions module 600 proceeds to step 621, entering a static loop of sorts until new data is ultimately received and identified in step 620. During step 621, the solutions module 600 may be configured to passively stand by for receipt of new data. In certain embodiments, the solutions module 600 may, in step 621, periodically (e.g., every 5 seconds, or at any desirable interval) proactively ping one or more databases contained therein. Various alternative data monitoring configurations may be envisioned, without departing the scope and nature of the present invention, as such are commonly known and understood in the art.

According to various embodiments, data received by the solutions module 600 may comprise any combination of customer data 501, historical data 502, and/or vendor data 503, although any of a variety of types of input data may be received, as may be applicable in certain scenarios. Such data may be entered by a user via exemplary interface screen displays (not shown), which may be accessed by one or more users and/or customers of the system 20. Alternatively, such data may be scanned, read, received, obtained, or other words used interchangeably herein, from various other sources, such as from a bar code, Maxi code, Quick Response (QR) code, character string, and/or the like.

Once the solutions module 600 receives data from, as a non-limiting example, the data module 500, the solutions module 600 may be configured to execute the solutions tool 601 at step 622. In various embodiments, the solutions tool 601 may be configured to identify one or more products and/or services to be offered to the potential customer. The products and/or services may be identified from a predetermined group of products and/or services, such as a group of products and/or services currently offered by the vendor. However, as will be understood by one skilled in the art, the solutions tool 601 may alternatively or additionally be configured to identify possible products and/or services that may be produced or supplied by the vendor, but which are not currently offered to customers and potential customers. In various embodiments, the solutions tool 601 may be configured to retrieve customer data 501 and/or vendor data 503 as necessary to determine the products and/or services to be offered to the potential customer at step 623. As a non-limiting example, the solutions tool 601 may utilize at least a subset of the customer data 501 to identify the products and/or services requested by the potential customer, or to identify those products and/or services that may be likely to result in some added value realized by the potential customer. In various embodiments, the solutions tool 601 may utilize at least a portion of the vendor data 503 to identify the products and/or services offered by the vendor. The vendor data 503 may contain detailed information regarding the products and/or services offered by the vendor, such as a list of products and/or services offered, or the vendor data 503 may contain general information regarding the range or types of products and/or services that are currently offered or that could be offered. As a non-limiting example, the vendor data 503 may specify that the vendor offers one or more specific shipping services, and the solutions tool 601 may be configured to identify the one or more specific shipping services offered by the vendor should be presented to the potential customer. As an additional non-limiting example, the vendor data 503 may specify that the vendor offers a range of shipping products and services, and the solutions tool 601 may be configured to identify possible shipping products and services to be offered to the potential customer based at least in part on the potential customer's stated request and/or data related to the potential customer's business.

Remaining with FIG. 7, the solutions tool 601 may be configured to generate proposed solutions data 602 comprising data regarding the identified products and/or services to be offered to the potential customer at step 624. The proposed solutions data 602 may be transmitted to the guarantee tool 603 for further processing at step 625. Once the guarantee tool 603 receives the proposed solution data 602, the solutions module 600 may be configured to execute the guarantee tool 603 at step 626 in order to identify a possible guaranteed added value to be offered to the potential customer. The guarantee tool 603 may be configured to retrieve customer data 501, historical data 502, and/or vendor data 503 as necessary in order to determine an appropriate guaranteed added value (step 627). As described above, the guarantee tool 603 may be configured to determine low-risk guaranteed added values to be offered to the potential customer based at least in part on the identified products and/or services to be offered to the potential customer. The guarantee tool 603 may utilize at least a portion of the vendor data 503 to determine the acceptable level of risk for a potential guaranteed added value, and to utilize this information to determine a guaranteed added value that meets the received acceptable level of risk criteria identified in the vendor data 503. The acceptable level of risk may be calculated from the perspective of the vendor or the potential customer. In various embodiments, the acceptable level of risk may be calculated individually for each potential customer, such that the vendor may have a different acceptable level of risk for different potential customers. As a non-limiting example, the vendor data 503 may specify that a potential customer must have at least a 95% chance of realizing the guaranteed added value prior to offering the guarantee to the customer. As an additional non-limiting example, the vendor data 503 may specify that, for a specified customer, that customer must have at least a 9% chance of realizing the guaranteed added value prior to offering the guarantee to that potential customer. The guarantee tool 603 may therefore be configured to determine a value for the guaranteed added value at a level such that the potential customer has at least a 95% chance of realizing the guaranteed added value through cost savings, increased revenue, and/or the like. The guaranteed added value determined by the guarantee tool 603 may comprise a total guaranteed added value (e.g., $50,000), a guaranteed added value per unit (e.g., $5 for each item shipped or $500 for each 100 items shipped), a guaranteed added value per unit of time (e.g., $5,000 per month), and/or the like.

The guarantee tool 603 may additionally be configured to determine any conditions or qualifications for meeting the acceptable level of risk for the guaranteed added value. Such conditions or qualifications may ensure that the potential customer cannot accept the vendor's proposal, fail to implement the provided products and/or services and/or fail to meet the specified conditions and/or qualifications, and collect the guaranteed added value from the vendor. As a non-limiting example, the guarantee tool 603 may determine that the potential customer must implement all of the products and/or services offered to the potential customer in order to receive the guarantee. Additionally, the guarantee tool 603 may specify that the potential customer must achieve a specified level of integration with the products and/or services offered by the vendor in order to receive the benefit of the guaranteed added value. As a non-limiting example, the guaranteed added value may require the potential customer to utilize the products and/or services supplied by the vendor for at least 75% of items shipped over a predetermined period of time. As an additional non-limiting example, the guaranteed added value may require the potential customer to utilize the products and/or services supplied by the vendor for at least 1,000 items shipped over a predetermined period of time. As will be understood by one skilled in the art, additional conditions and/or qualifications may be implemented in various embodiments. At step 628 of FIG. 7 the guarantee tool 603 may be configured to generate proposed guarantee data 604 based at least in part on the proposed solution data 602, the determined acceptable level of risk, and/or any conditions or qualifications established for meeting the acceptable level of risk for the guaranteed added value.

In various embodiments, the guarantee tool 603 may additionally be configured to generate metric data 605 comprising metrics that may be used to determine whether the potential customer realizes added value at least in part attributable to products and/or services provided by the vendor. As a non-limiting example, the guarantee tool 603 may determine that the total shipping expenditures of a potential customer is a possible metric for determining whether the potential customer realized a cost savings after implementing shipping products and/or services provided by the vendor. As an additional non-limiting example, the guarantee tool 603 may identify the per unit cost of shipping an item (e.g., the cost to ship one item) as a metric for determining the total savings realized by the potential customer on shipping services that is at least in part attributable to the products and/or services provided by the vendor. As will be understood by one skilled in the art, alternative metrics may be implemented in various embodiments.

In various embodiments, the solutions module 600 may be configured to receive data (e.g., accepted proposal data 704, described in detail below) from the proposal module 700 at step 620. The solutions module 600 may be configured to execute the solutions tool 601 and guarantee tool 603 as described above, and utilize the accepted proposal data 704 to generate proposed solution data 602 and proposed guarantee data 604 based at least in part on the accepted proposal data 704.

According to various embodiments, during step 629, the solutions module 600 is configured to transmit at least a portion of data (e.g., customer data 501, historical data 502, vendor data 503, proposed solution data 602, proposed guarantee data 604, and/or metric data 605) to at least the proposal module 700. In certain embodiments, portions of the data may be alternatively and/or additionally transmitted to the data module 500 and/or the monitor module 800. In these and other embodiments, such transmission to various modules may be simultaneous, while in still other embodiments, transmission may be sequential and temporally spaced, as may be desirable or necessary for particular applications. Still further, in certain embodiments, the solutions module 600 may be configured to automatically perform step 629, while in other embodiments, the module may perform such only periodically, at an interval predetermined by one or more users of the system 20, as may be desirable for particular applications. In any of these and still other embodiments, any portion of the data may be otherwise exchanged, whether automatically or upon request therefor, with or from the remaining modules 500, 700-900, as may be desirable for certain applications, as compared with the provision of such data from and by the solutions module 600 as an initiator thereof.

In various embodiments, the solutions module 600 may be configured to allow a user of the system 20 to review the generated data (e.g., proposed solutions data 602, proposed guarantee data 604, and/or metric data 605) prior to transmission of the generated data to other modules. Additionally, the solutions module 600 may be configured to receive user input modifying the generated data prior to transmission to other modules. As a non-limiting example, the solutions module 600 may be configured to receive an input from a user of the system 20 changing the guaranteed added value prior to transmission to the proposal module 700. As an added non-limiting example, the solutions module 600 may be configured to receive a user input separate from data contained in the data module 500 describing, identifying, or selecting various products and/or services to be offered to the potential customer. In various embodiments, the solutions module 600 may be configured to accept user input describing a product and/or service not previously offered by the vendor and/or outside of the range of products and/or services offered by the vendor. As may be understood by one skilled in the art, the solutions module 600 may be configured to execute the guarantee tool 603 after receiving user input modifying or adding the proposed solution data 602. Alternatively, the solutions module 600 may be configured to require an additional user input modifying or adding the proposed guarantee data 604 and/or metric data 605 prior to transmitting the data to other modules.

Proposal Module 700

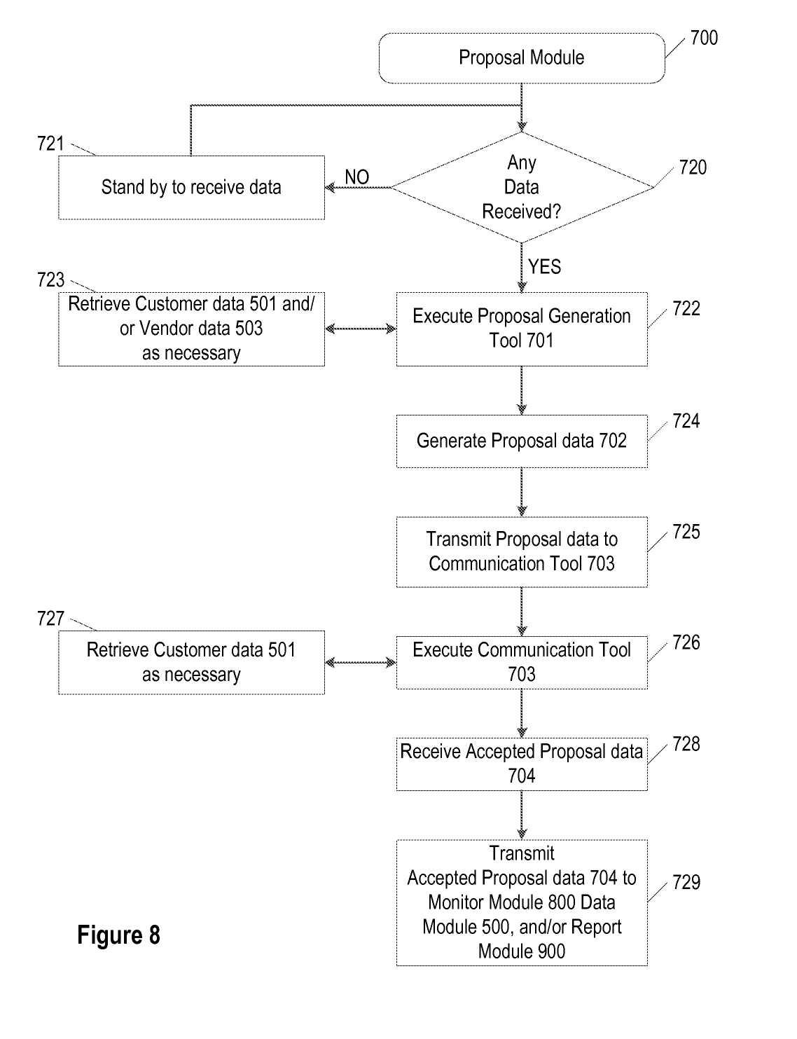

As previously described, upon receipt and/or retrieval of any portion of data (e.g., proposed solutions data 602, proposed guarantee data 604, and/or metric data 605), the proposal module 700 is configured to at least execute one or more tools to generate a proposal to be presented to a potential customer and to transmit the proposal to the potential customer. In at least the illustrated embodiment of FIG. 8, such tools may comprise a proposal generation tool 701 and a communication tool 703, although additional and/or alternative tools may be provided. The tools 701, 703 may be configured to generate proposal data 702 and accepted proposal data 704, respectively. Further details in this regard are provided below.

With reference now to FIG. 8, which illustrates the various steps that may be executed by the proposal module 700, according to various embodiments the proposal module 700 is configured to begin at step 720 by determining whether any data has been received by the proposal module 700. As will be understood by one skilled in the art, the proposal module 700 may utilize procedures similar to those described above in relation to steps 520-521 executed by the data module 500. However, as will be understood by one skilled in the art, the proposal module 700 may operate in a manner different from the data module 500. As a non-limiting example, the proposal module 700 may be configured to periodically and/or continuously proactively retrieve and/or check for new data, as may be transmitted from the data module 500 and/or solutions module 600. In other embodiments, the proposal module 700 may merely passively await receipt of data from the data module 500 and/or solutions module 600, as may be desirable for particular applications.

Otherwise, if no data is received in step 720, the proposal module 700 proceeds to step 721, entering a static loop of sorts until new data is ultimately received and identified in step 720. During step 721, the proposal module 700 may be configured to passively stand by for receipt of new data. In certain embodiments, the proposal module 700 may, in step 721, periodically (e.g., every 5 seconds, or at any desirable interval) proactively ping one or more databases contained therein. Various alternative data monitoring configurations may be envisioned, without departing the scope and nature of the present invention, as such are commonly known and understood in the art.

According to various embodiments, data received by the proposal module 700 may comprise any combination of customer data 501, historical data 502, vendor data 503, proposed solutions data 602, proposed guarantee data 604, and/or metric data 605, although any of a variety of types of input data may be received as may be applicable in certain scenarios. Such data may be entered by a user via exemplary interface screen displays (not shown), which may be accessed by one or more users of the system 20, or it may be otherwise received from the data module 500 and/or solutions module 600.

Once the proposal module 700 receives data from, as a non-limiting example, the data module 500 and/or the solutions module 600, the proposal module 700 may be configured to execute the proposal generation tool 701 at step 722. The proposal generation tool 701 may be configured to generate a bid package comprising a proposal to be presented to the potential customer. At step 723, the proposal generation tool 701 may be configured to retrieve customer data 501 and/or vendor data 503 as necessary to determine the appropriate format in which to present the proposal. As described above, the potential customer may specify a required format in which to present the proposal, and therefore the proposal generation tool 701 may be configured retrieve at least a portion of the customer data 501 that specifies the required format to be used for the potential customer. Alternatively, the proposal generation tool 701 may be configured to retrieve at least a portion of the vendor data 503 to determine an appropriate format in which to present the proposal to the potential customer. In various embodiments, the proposal generation tool 701 may be configured to utilize a standard proposal format in which to present the proposal to the potential customer, or the proposal generation tool 701 may be configured to identify an appropriate format in which to present the proposal based at least in part on the content of the proposal, the potential customer to which it will be presented, and/or the like.

In various embodiments, the proposal generation tool 701 may be configured to utilize vendor data 503 in order to identify products and/or services that are considered confidential. In various embodiments, the proposal generation tool 701 may be configured to only identify those products and/or services not considered confidential in the generated proposal. Alternatively, the proposal generation tool 701 may be configured to include only the guaranteed added value and a description of the requirements for the potential customer to accept and receive the guaranteed added value, and thus omit information regarding the underlying products and/or services. As a non-limiting example, the proposal generation tool 701 may include a requirement that the potential customer must be willing to accept any products and/or services provided by the vendor, or else the vendor will not honor the guaranteed added value.

Remaining with FIG. 8, the proposal generation tool 701 may be configured to generate proposal data 702 comprising the proposal to be presented to the potential customer at step 724. The proposal data 702 may be transmitted to the communication tool 703 for transmission to the potential customer at step 725. Once the communication tool 703 receives the proposal data 701, the proposal module 700 may be configured to execute the communication tool 703 at step 726 and transmit the proposal to the potential customer. The communication tool 703 may be configured to retrieve customer data 501 as necessary in order to determine the appropriate entity to which to transmit the proposal (step 627). As described above, the communication tool 703 may be in communication with a network 130 and may be configured to transmit the proposal to the potential customer using one or more of a variety of communication methods. As a non-limiting example, the communication tool 703 may be configured to transmit the proposal to the potential customer via email, text message, fax, and/or the like. In various embodiments, the communication tool 703 may be in communication with a printing device (e.g., an inkjet printer, laser printer, and/or the like) configured to create a hard copy of the proposal to be sent to the potential customer using a shipping service. In these and other embodiments, any of a variety of means of delivery as commonly known and understood in the art may be utilized.

In various embodiments, the communication tool 703 may additionally be configured to receive transmissions from the potential customer regarding the proposal data 702. In various embodiments, the communication tool 703 may be configured to receive accepted proposal data 704 from the potential customer at step 728. In various embodiments, the accepted proposal data 704 may comprise data confirming that the potential customer accepted the guaranteed added value and chose to implement the products and/or services required to obtain the guaranteed added value. Alternatively, the accepted proposal data 704 may comprise a counter-offer by the potential customer regarding products and/or services requested, and/or a new guaranteed added value. As described above, the proposal module 700 may be configured to transmit the accepted proposal data 704 to the solutions module 600 in order to determine whether the counter-offer may be accepted by the vendor. The proposal module 700 may be configured to transmit a new proposal to the potential customer after the solutions module 600 identifies the products and/or services and the guaranteed added value to be offered to the potential customer in response to the counter-offer.

After receiving accepted proposal data 704 indicating that the potential customer accepts the proposal, the communication tool 703 may be configured to transmit additional information regarding the products and/or services to be provided by the vendor. As a non-limiting example, the communication tool 703 may be configured to transmit information regarding the previously undisclosed products and/or services to be provided to the potential customer (e.g., confidential products and/or services). In various embodiments, the proposal module 700 may be configured to transmit and receive a Non-Disclosure Agreement (NDA) or confidentiality agreement prior to revealing additional information to the potential customer. As a non-limiting example, the vendor may include certain proprietary products, methods, and/or the like (collectively referred to herein as “proprietary services”) as a part of those products and/or services provided to the potential customer. In such circumstances, the proposal module 700 may be configured to receive a contractual agreement with the potential customer stating that the potential customer will not share information regarding such proprietary services without the authorization of the vendor.

Alternatively, if the potential customer rejects the proposal, the communication tool 703 may be configured to receive notification of the rejection and transmit this information to the data module 500. Additionally, if the communication tool 703 receives a rejection from the potential customer, the proposal tool 700 may be configured to terminate the process after transmitting the rejection data to the data module 500. In various embodiments, the data module 500 may be configured to update the historical data 502 to include the rejection data received by the communication tool 703.

At step 729, the proposal module 700 may be configured to transmit at least a portion of data (e.g., customer data 501, historical data 502, vendor data 503, proposed solution data 602, proposed guarantee data 604, metric data 605, and/or accepted proposal data 704) to at least the monitor module 800. In certain embodiments, portions of the data may be alternatively and/or additionally transmitted to the data module 500 and/or the solutions module 600. In these and other embodiments, such transmission to various modules may be simultaneous, while in still other embodiments, transmission may be sequential and temporally spaced, as may be desirable or necessary for particular applications. Still further, in certain embodiments, the proposal module 700 may be configured to automatically perform step 729, while in other embodiments, the module may perform such only periodically, at an interval predetermined by one or more users of the system 20, as may be desirable for particular applications. In any of these and still other embodiments, any portion of the data may be otherwise exchanged, whether automatically or upon request therefor, with or from the remaining modules 500, 600, 800, 900 as may be desirable for certain applications, as compared with the provision of such data from and by the proposal module 700 as an initiator thereof.

In various embodiments, the proposal module 700 may be configured to allow a user of the system 20 to review the generated data (e.g., proposal data 702) prior to the transmission of data to the potential customer. Additionally, the proposal module 700 may be configured to receive user input modifying the generated data prior to transmission to the potential customer. As a non-limiting example, the proposal module 700 may be configured to receive an input from a user modifying the proposal prior to transmission to the potential customer. In various embodiments, the proposal module 700 may be configured to execute the communication tool 703 after receiving user input modifying or adding the proposal data 702.

Monitor Module 800

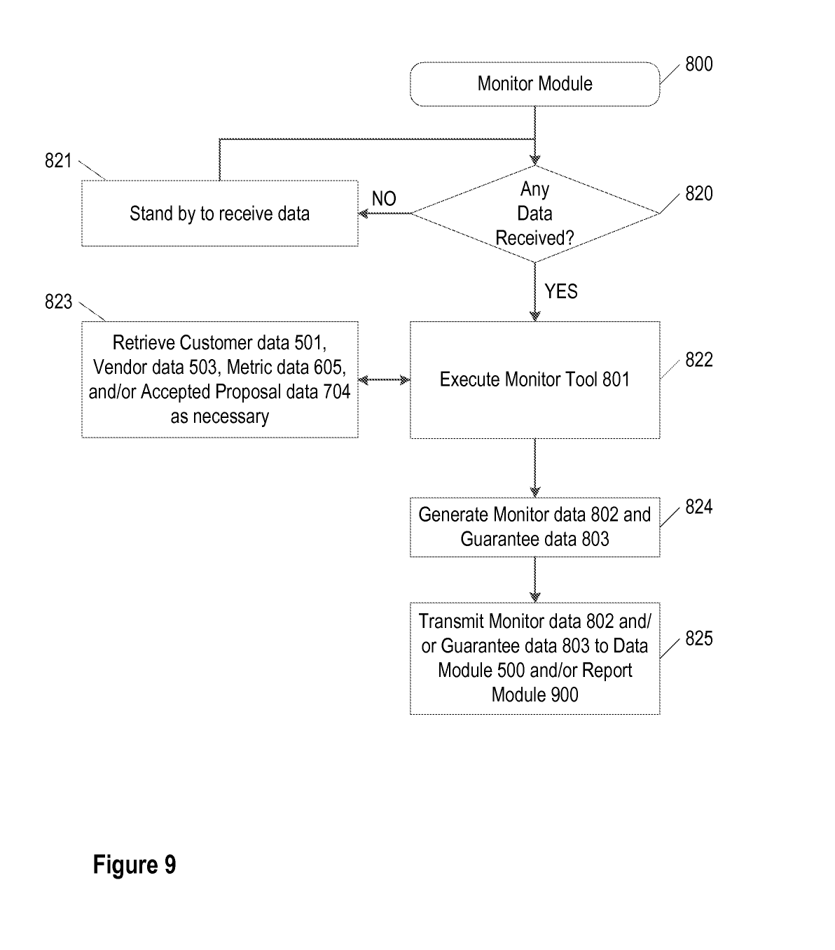

As previously described, upon receipt and/or retrieval of any portion of data (e.g., proposed solutions data 602, proposed guarantee data 604, metric data 605, proposal data 702, and/or accepted proposal data 704), the monitor module 800 may be configured to at least execute one or more tools to monitor the added value realized by the potential customer that is at least in part attributable to the products and/or services provided by the vendor. In at least the illustrated embodiment of FIG. 9, the monitor tool 801 may be configured to perform the steps involved in monitoring the added value realized by the potential customer that is at least in part attributable to the products and/or services provided by the vendor, although additional and/or alternative tools may be provided. Further details in this regard are provided below.

With reference now to FIG. 9, which illustrates the various steps that may be executed by the monitor module 800, according to various embodiments the monitor module 800 is configured to begin at step 820 by determining whether any data has been received by the monitor module 800. As will be understood by one skilled in the art, the monitor module 800 may utilize procedures similar to those described above in relation to steps 520-521 executed by the data module 500. However, as will be understood by one skilled in the art, the monitor module 800 may operate in a manner different from the data module 500. As a non-limiting example, the monitor module 800 may be configured to periodically and/or continuously proactively retrieve and/or check for new data, as may be transmitted from the data module 500, solutions module 600, and/or proposal module 700. In other embodiments, the monitor module 800 may merely passively await receipt of data from the data module 500, solutions module 600, and/or proposal module 700, as may be desirable for particular applications.

Otherwise, if no data is received in step 820, the monitor module 800 proceeds to step 821, entering a static loop of sorts until new data is ultimately received and identified in step 820. During step 821, the monitor module 800 may be configured to passively stand by for receipt of new data. In certain embodiments, the monitor module 800 may, in step 821, periodically (e.g., every 5 seconds, or at any desirable interval) proactively ping one or more databases contained therein. Various alternative data monitoring configurations may be envisioned without departing the scope and nature of the present invention, as such are commonly known and understood in the art.

According to various embodiments, data received by the monitor module 800 may comprise any combination of customer data 501, historical data 502, vendor data 503, proposed solutions data 602, proposed guarantee data 604, metric data 605, proposal data 602, and/or accepted proposal data 604, although any of a variety of types of input data may be received, as may be applicable in certain scenarios. Such data may be entered by a user via exemplary interface screen displays (not shown), which may be accessed by one or more users of the system 20. In various embodiments, the monitor module 800 may be configured to receive data from products implemented by the vendor. As a non-limiting example, a computer or computer program product provided by the vendor may be configured to automatically transmit data to the monitor module 800.

Once the monitor module 800 receives data from, as a non-limiting example, the data module 500, the solutions module 600, and/or the proposal module 700, the monitor module 800 may be configured to execute the monitor tool 801 at step 822. The monitor tool 801 may be configured to determine the total added value amount realized by the potential customer that is at least in part attributable to the products and/or services provided by the vendor. The monitor tool 801 may be configured to retrieve customer data 501, vendor data 503, metric data 605, and/or accepted proposal data 704 as necessary in order to determine the added value amount attributable to the products and/or services provided by the vendor (step 823). In various embodiments, the monitor tool 801 may be configured to utilize the data associated with the metrics identified in the metric data 605 in order to determine the added value realized by the potential customer and at least in part attributable to the products and/or services provided by the vendor. In various embodiments, the data may be provided by the potential customer and received by the data module 500. Alternatively, the monitor tool 801 may be configured to receive data regarding the added value realized by the potential customer directly from the potential customer. The monitor module 801 may additionally be configured to determine whether the potential customer has met the requirements identified in the proposal for receiving the benefit of the guaranteed added value. As a non-limiting example, the monitor tool 801 may be configured to determine whether the potential customer met an integration requirement included in the proposal. As an additional non-limiting example, the monitor tool 801 may be configured to determine whether a potential customer met the requirement that at least 75% of all items shipped by the potential customer must utilize the products and/or services provided by the vendor.

Remaining with FIG. 9, at step 824 the monitor tool 801 may be configured to generate monitor data 802 and/or guarantee data 803 comprising data regarding the amount of added value realized by the potential customer and at least in part attributable to the products and/or services provided by the vendor, and data regarding whether the potential customer realized the guaranteed added value. The monitor data 802 and/or guarantee data 803 may be transmitted to the data module 500 and/or the report module 900 at step 825. In various embodiments, the historical data 502 may be updated to include the monitor data 802 and/or guarantee data 803 generated by the monitor tool 801. Moreover, as described herein, the data transmitted to the report module 900 may be utilized to generate one or more alerts regarding the implementation of the products and/or services.

In various embodiments, the monitor module 800 may additionally be configured to inform a user of the system 20 if the potential customer did not realize the guaranteed added value. The monitor module 800 may, in various embodiments, generate a report to be sent to an identified user of the system 20 that indicates the difference between the added value amount realized and the guaranteed added value. Additionally, monitor module 800 may be configured to indicate whether the potential customer met all the requirements necessary to obtain the benefit of the guaranteed added value.

In various embodiments, the monitor module 800 may be configured to allow a user of the system 20 to review the generated data (e.g., monitor data 802 and guarantee data 803) prior to the transmission of data to the data module 500 and/or the report module 900. Additionally, the monitor module 800 may be configured to receive user input modifying the generated data prior to transmission of the data to the data module 500 and/or the report module 900. It should be understood as well that any of a variety of configurations, whether automatic, semi-automatic, manual requiring approval, or otherwise may be envisioned, as considered within the scope and nature of the various embodiments of the system 20 described herein.

Report Module 900

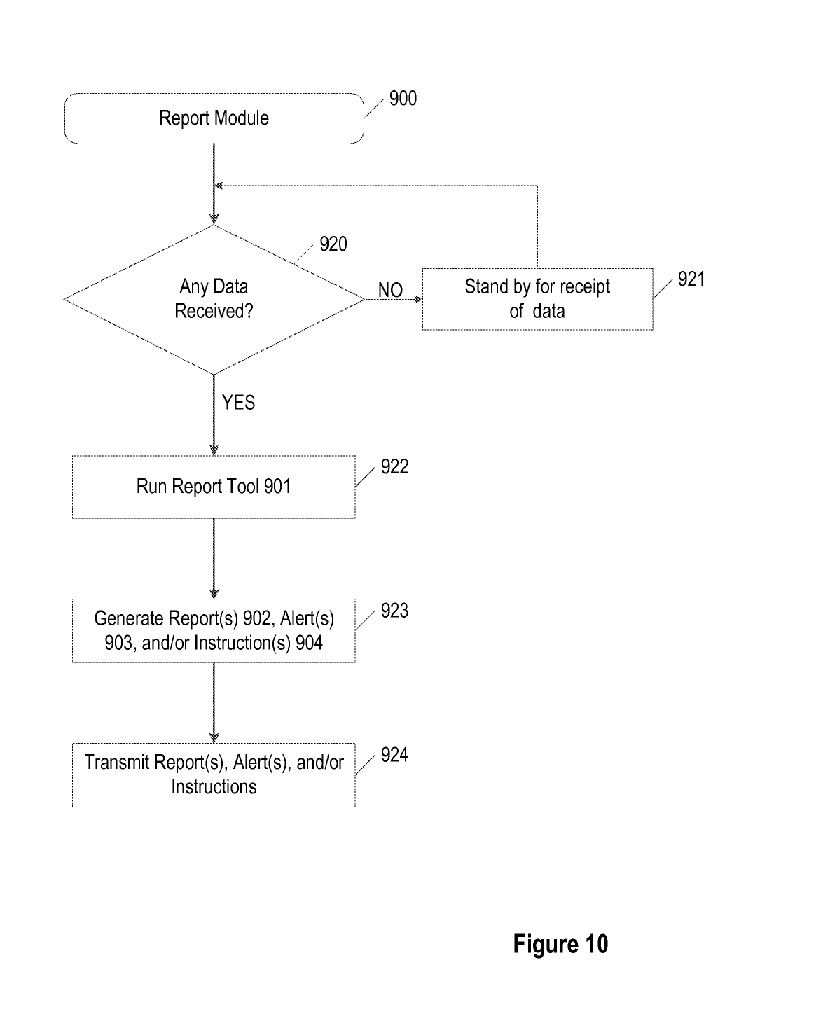

With reference to FIG. 10, according to various embodiments, the report module 900 is configured to generate one or more reports 902 and/or alerts 903 to one or more users of the system 20 (or other parties, such as representatives of a potential customer), as may be desirable according to particular applications. In certain embodiments, the reports 902 and/or alerts 903 may be based at least in part upon the generated proposed solutions data 602, proposed guarantee data 604, metric data 605, proposal data 702, accepted proposal data 704, monitor data 802, and/or guarantee data 803, as have been previously described herein, although in other embodiments other data may be additionally or alternatively incorporated therewith (e.g., customer data 501). It should be understood, however, that according to various embodiments the report module 900 is configured so as to facilitate users of the system 20 obtaining real-time or near real-time data from which they can assess, monitor, and/or revise the proposed solutions, proposed guaranteed added value, accepted solutions, and/or the realized added value amount, so as to efficiently monitor the progress of the system 20 in generating and monitoring solutions.

In various embodiments, the report module 900 may receive data from any of the other modules, 500, 600, 700, 800, and generate reports 902 and/or alerts 903 in order to notify a user of the system 20 of the generation of some form of data. In various embodiments, the report module 900 may be configured to generate reports 902 and/or alerts 903 upon the occurrence of predetermined events. As a non-limiting example, the report module 900 may be configured to generate a report 902 in response to a determination that a proposal has been transmitted to the potential customer by the proposal module 700. As an additional non-limiting example, the report module 900 may be configured to generate a report 902 upon a determination by the monitor module 800 that the potential customer has realized at least the guaranteed added value.

The report module 900 may be configured to selectively generate reports 902 and/or alerts 903 that are transmitted to various users of the system 20, or other third parties. Returning to the previously described non-limiting example, upon a determination that the potential customer realized at least the guaranteed added value, the report module 900 may be configured to transmit a report 902 at least to one or more specified users of the system 20. However, as will be understood by one skilled in the art, the report module 900 may also be configured to make reports 902 and/or alerts 903 available to users of the system 20 or third parties through a web-page or alternative means of informing users of particular reports 902 and/or alerts 903.

With focus again on FIG. 10, in any of these and still other various embodiments, if “newly received” data is identified in step 920, the report module 900 proceeds to step 922; otherwise the module proceeds into a static loop via step 921, pending receipt of new data. During step 921, the report module 900 may be configured to passively stand by for receipt of data. In certain embodiments, the report module 900 may, in step 921, periodically (e.g., every 5 seconds, or at any desirable interval) proactively ping one or more databases contained within the data module 500, as may be desirable. In certain embodiments, the report module 900 may ping or otherwise be in periodic or continuous communication with the solutions module 600, proposal module 700, and/or the monitor module 800 as well. Of course, various alternative data monitoring configurations may be envisioned, without departing from the scope and nature of the present invention, as such are commonly known and understood in the art.

During step 922, the report module 900 is configured to run a report tool 901, which is generally configured to generate, in step 923, one or more reports 902, alerts 903, and/or instructions 904 based at least in part upon the proposed solutions data 602, proposed guarantee data 604, metric data 605, proposal data 702, accepted proposal data 704, monitor data 802, and/or guarantee data 803. In various embodiments, the report tool 901 may be configured to generate one or more reports 902 and/or alerts 903 upon the generation of proposed solution data 602, proposed guarantee data 603, and/or metric data 604 prior to the generation of a proposal to be transmitted to a potential customer. The reports 902 and/or alerts 903 may indicate that the data is ready for review, and, in various embodiments, the system 20 may be configured so as to generate proposal data 702 after receiving an indication of approval from a user of the system 20. In certain embodiments, the report tool 901 may be configured to generate a report 902 and/or alert 903 to notify a user of the system 20 that a proposal is sent to a potential customer. The report tool 901 may additionally, or alternatively, be configured to generate a report 902 and/or alert 903 upon a determination that accepted proposal data 704 has been generated or received by the proposal module 700. Moreover, the report tool 901 may be configured to generate one or more instructions 904 that may be automatically or manually completed, depending on the content of the accepted proposal data 704. As a non-limiting example, if the accepted proposal data 704 indicates that the potential customer accepts the proposal transmitted from the vendor, the report tool 901 may be configured to generate instructions to facilitate implementation of the proposed solutions. As an additional non-limiting example, if the accepted proposal data 704 indicates that the potential customer has rejected the transmitted proposal, or the potential customer has transmitted a counter offer, the report tool 901 may be configured to generate instructions for the solutions module 600 to generate a new or additional proposed solutions, or instructing a user of the system to abandon the proposal.

The report tool 901 may additionally be configured to generate reports 902, alerts 903 and/or instructions 904 in response to data received from, as a non-limiting example, the monitor module 800. In various embodiments, the report tool 901 may be configured to generate an alert 903 for a user of the system 20 in response to a determination that the potential customer did not realize the guaranteed added value in accordance with the accepted proposal. The report tool 901 may additionally, or alternatively, be configured to generate an alert 903 and/or a report 902 for a user of the system 20 in response to a determination that the potential customer is not likely to realize the guaranteed added value in accordance with the accepted proposal. Such a determination may be made periodically, or in response to a user request. As a non-limiting example, the report tool 901 may be configured to generate an alert 903 and/or report 902 upon a determination that the potential customer is not likely to realize the guaranteed added value made after a predetermined period of time (e.g., 2 months), a predetermined volume (e.g., 2000 items shipped), a predetermined potential customer expenditure (e.g., $20,000 spent on shipping services), and/or the like.

As will be understood by one skilled in the art, the report tool 901 may be configured to generate a report 902 regarding the status of the implementation of the products and/or services provided by the vendor, regardless of the likelihood of the potential customer realizing the guaranteed added value. In various embodiments, the report tool 901 may be configured to generate a report 902 after a predetermined period of time (e.g., every 2 months after implementation), a predetermined volume (e.g., every 1000 items shipped), a predetermined expenditure (e.g., every $5,000 spent on shipping services), and/or the like. Moreover, certain embodiments may be configured to generate a report 902 and/or an alert 903 upon a determination that the potential customer has realized the guaranteed added value.

In various embodiments, the report tool 901 may additionally be configured to generate a report 902 and/or an alert 903 in response to a determination that the potential customer is not complying with the requirements, conditions, and/or qualifications associated with the guaranteed added value. As a non-limiting example, the report tool 901 may be configured to generate an alert 903 to be transmitted to a user of the system 20 upon a determination that the potential customer is not shipping a sufficient number of items each month using the vendor-provided services in order to reach the guaranteed added value. The report tool 901 may additionally be configured to generate one or more instructions 904 to be transmitted to either the potential customer and/or one or more users of the system 20 comprising, as a non-limiting example, instructions to comply with the applicable requirements, or to terminate the contractual relationship with the potential customer.

According to various embodiments, alerts 902 may be generated primarily for purposes of notification upon a determination that the potential customer has not realized the guaranteed added value. In certain embodiments, reports 902 may be generated primarily to facilitate the payout of value from the vendor to the potential customer upon a determination that the guaranteed added value was not fulfilled. In various embodiments, reports 902 and/or alerts 903 may be generated upon a determination that the potential customer is not likely to realize the guaranteed added value, such that remedial action can be taken, such as adding or modifying the provided products and/or services. As previously noted, reports 902 and/or alerts 903 may be generated in response to the solutions module 600 generating proposed solutions data 602, proposed guarantee data 604, and/or metric data 605. These reports, which may be generated prior to transmission of a proposal to a potential customer, may allow users of the system 20 to review and/or modify the proposed solutions and/or guarantees prior to generating a proposal. The timing and distinctions between the delivery and transmission of the reports versus (and/or) alerts may be based upon any of a variety of preferences, even regulatory requirements, vendor requirements, potential customer preferences or requirements, and/or common carrier preferences or requirements, as may be applicable in various contexts.

It should also be understood, returning to FIG. 10, that according to various embodiments, during step 924, any combination of the reports 902 and/or alerts 903 that may have been generated, as may be influenced by previously defined parameters, whether by third parties or other users of the system 20, may be further transmitted (via one or more networks or otherwise) to one or more additional users or associated entities of the system 20. For example, upon generation of an alert 903 that the potential customer is not likely to realize the guaranteed added value, an indication thereof may be transmitted to at least the vendor for notification thereof so that mitigation actions and/or the like may be taken so as to seek to avoid actual occurrence of the violation. As a non-limiting example, the vendor may be able to add or modify the provided products and/or services so as to increase the possibility that the potential customer will realize the guaranteed added value. Various scenarios may be envisioned, further including the non-limiting examples of: notification of the transmission of a proposal to a potential customer, notification that monitor data 802 has been received and/or generated, notification that customer data 501 has been received and/or generated, notification that a potential customer is likely to realize the guaranteed added value, and/or the like.

Noting further in FIG. 10, it should be emphasized that in those embodiments incorporating a monitor module 800, the report module 900 may be further configured in steps 923 and 924 to generate and transmit one or more instructions 904, as may have been generated by the report tool 901 to facilitate implementation of mitigation actions to eliminate or otherwise address a determination that a potential customer is not likely to realize the guaranteed added value, or to facilitate a payout to a potential customer upon a determination that the potential customer did not realize the guaranteed added value. Such instructions 904 may be transmitted separately from reports and/or alerts, as configured in the sense described previously herein according to various embodiments. In other embodiments, the instructions 904 may be transmitted within (e.g., as embedded portions of) otherwise generated reports 902 and/or alerts 903. In certain embodiments, the reports and/or alerts containing instructions 904 may require user authorization or approval of further action; however, in other embodiments, the reports and instructions may be simply informative of mitigating actions being commenced, as may be determined at least in part by pre-established user preferences and parameters for determination and implementation of mitigating actions.

It should be understood that while the alerts 903 and reports 902 described herein may be transmitted periodically and with differing timetables respective to one another, the basis of both generating and transmitting the same may also further differ. For example, alerts may be reserved for actions for which user (or third party entity) approval is necessary for further action, as a non-limiting example, where approval is necessary to implement mitigation actions, whether due to the cost incurred thereby or for alternative reasons. Reports may be simply informative, requiring no further positive action or interaction from the recipient thereof with the system 20. In such embodiments, reports, both with respect to content and the frequency thereof, may be established and even pre-established by any of the variety of users of the system, including non-users of the system to which notification or reporting may be mandated by various regulations or user preferences. The formatting of such reports and/or alerts may also be customized, as may be desired for particular users of the system. Indeed, additional and/or alternative formats of reporting and/or communication may be envisioned without departing from the scope and intent of the present invention, and any of those, like those described previously herein, may be implemented in a manual or automatic fashion, electronically or otherwise, however as may be desirable.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for providing a guaranteed added value, the method comprising the steps of:
receiving and storing in one or more memory storage areas:
customer data associated with at least one potential customer; and
vendor data associated with one or more products potentially offerable to the at least one potential customer;
determining, via one or more computer processors, one or more products to be offered to the potential customer, the one or more offered products being selected from the one or more potentially offerable products;
determining, via the one or more computer processors, a guaranteed added value for the potential customer utilizing the products to be offered based at least in part upon a comparison of the customer data and the products to be offered to the potential customer;
implementing the products to be offered to the potential customer;
monitoring, via the one or more computer processors, the implemented products to determine a total added value amount realized by the potential customer;
comparing, via the one or more computer processors, the total added value amount realized by the potential customer and the guaranteed added value;
in response to a determination that the amount realized is greater than or equal to the guaranteed added value, generating, via the one or more computer processors, a communication to one or more users notifying the one or more users of the determination; and
in response to a determination that the amount realized is less than the guaranteed added value, facilitating, via the one or more computer processors, a payout to the potential customer.

2. The method of claim 1, wherein the products to be offered to the potential customer comprise one or more services offered by the vendor.

3. The method of claim 1, wherein the guaranteed added value comprises at least one of: a cost savings or a revenue increase.

4. The method of claim 1, wherein the payout comprises an amount of currency at least equal to the difference between the total added value amount realized by the potential customer and the guaranteed added value.

5. The method of claim 1, wherein the payout comprises one or more additional products provided by the vendor.

6. The method of claim 5, wherein the one or more additional products are configured to alleviate the difference between the amount realized and the guaranteed added value.

7. The method of claim 1, wherein the guaranteed added value is determined based at least in part on an acceptable level of risk.

8. The method of claim 7, wherein the acceptable level of risk comprises a value representing the minimum chance that the potential customer will realize the guaranteed added value in total added value.

9. The method of claim 7, wherein the acceptable level of risk comprises a value representing the maximum chance that the potential customer will realize the guaranteed added value in total added value.

10. The method of claim 1, further comprising the step of transmitting, via the one or more computer processors, a proposal comprising the guaranteed added value to a potential customer.

11. The method of claim 10, wherein the proposal comprises a limited disclosure of the products to be offered to the potential customer.

12. The method of claim 1, further comprising the step of generating, via the one or more computer processors, a communication to one or more users notifying the one or more users of the determination that the amount realized is less than the guaranteed added value.

13. The method of claim 1, wherein the step of monitoring the implemented products to determine a total added value amount realized by the potential customer comprises the steps of:
generating, via the one or more computer processors, metric data comprising one or more metrics for measuring the total added value realized by the potential customer;
receiving, via the one or more computer processors, data representative of the total added value realized by the potential customer; and
determining, via the one or more computer processors, whether the total added value realized by the potential customer is at least in part attributable to the products to be offered to the potential customer.

14. A system for providing a guaranteed added value,
said system comprising one or more memory storage areas; and
one or more computer processors configured to:
receive and store in the one or more memory storage areas:
customer data associated with at least one potential customer; and
vendor data associated with one or more products potentially offerable to the at least one potential customer;
determine one or more products to be offered to the potential customer, the one or more offered products being selected from the one or more potentially offerable products;
determine a guaranteed added value for the potential customer utilizing the products to be offered based at least in part upon a comparison of the customer data and the products to be offered to the potential customer;
implement the products to be offered to the potential customer;
monitor the implemented products to determine a total added value amount realized by the potential customer;
compare the total added value amount realized by the potential customer and the guaranteed added value;
in response to a determination that the amount realized is greater than or equal to the guaranteed added value, generate a communication to one or more users notifying the one or more users of the determination; and
in response to a determination that the amount realized is less than the guaranteed added value, facilitate a payout to the potential customer.

15. The system of claim 14, wherein the products to be offered to the potential customer comprise one or more services offered by the vendor.

16. The system of claim 14, wherein the guaranteed added value comprises at least one of: a cost savings and a revenue increase.

17. The system of claim 14, wherein the payout comprises an amount of currency at least equal to the difference between the total added value amount realized by the potential customer and the guaranteed added value.

18. The system of claim 14, wherein the payout comprises one or more additional products to be provided by the vendor.

19. The system of claim 18, wherein the one or more additional products are configured to alleviate the difference between the amount realized and the guaranteed added value.

20. The system of claim 14, wherein the guaranteed added value is determined based at least in part on an acceptable level of risk, wherein the acceptable level of risk comprises at least one of a minimum chance or a maximum chance that the potential customer will realize the guaranteed added value in total added value.

21. The system of claim 14, wherein the one or more computer processors are further configured to transmit a proposal comprising the guaranteed added value to a potential customer.

22. The system of claim 21, wherein the proposal comprises a limited disclosure of the products to be offered to the potential customer.

23. The system of claim 14, wherein the one or more computer processors are further configured to generate a communication to one or more users notifying the one or more users of the determination that the amount realized is less than the guaranteed added value.

24. The system of claim 14, wherein the one or more computer processors are further configured to:
generate metric data comprising one or more metrics for measuring the total added value realized by the potential customer;
receive data representative of the total added value realized by the potential customer; and
determine whether the total added value realized by the potential customer is at least in part attributable to the products to be offered to the potential customer.

25. A non-transitory computer program product comprising at least one computer-readable storage medium having computer-readable program code portions embodied therein, the computer-readable program code portions comprising:
an executable portion configured for receiving and storing in one or more memory storage areas:
customer data associated with at least one potential customer; and
vendor data associated with one or more products potentially offerable to the at least one potential customer;
an executable portion configured for determining, via one or more computer processors, one or more products to be offered to the potential customer, the one or more offered products being selected from the one or more potentially offerable products;
an executable portion configured for determining, via the one or more computer processors, a guaranteed added value for the potential customer utilizing the products to be offered based at least in part upon a comparison of the customer data and the products to be offered to the potential customer;
an executable portion configured for implementing the products to be offered to the potential customer;
an executable portion configured for monitoring, via the one or more computer processors, the implemented products to determine a total added value amount realized by the potential customer;
an executable portion configured for comparing, via the one or more computer processors, the total added value amount realized by the potential customer and the guaranteed added value;
an executable portion configured for, in response to a determination that the amount realized is greater than or equal to the guaranteed added value, generating, via the one or more computer processors, a communication to one or more users notifying the one or more users of the determination; and
an executable portion configured for, in response to a determination that the amount realized is less than the guaranteed added value, facilitating, via the one or more computer processors, a payout to the potential customer.
